(19) United States
(12) Patent Application Publication
(10) Pub. No.: US 2026/0001358 A1
(43) Pub. Date: Jan. 1, 2026

(54) MEDIUM PLACEMENT DEVICE

(71) Applicant: SEIKO EPSON CORPORATION, Tokyo (JP)

(72) Inventor: Koki MURAKAMI, AGEMATSU-MACHI (JP)

(21) Appl. No.: 19/248,803

(22) Filed: Jun. 25, 2025

(30) Foreign Application Priority Data
Jun. 28, 2024 (JP) 2024-105418
Mar. 21, 2025 (JP) 2025-046254

(51) Int. Cl. B41J 13/10; B41J 13/30

(52) U.S. Cl. CPC B41J 13/103; B41J 13/30

(57) ABSTRACT

It includes a placement section on which medium can be placed, a first edge guide configured to align an edge of the medium placed on the placement section, and a first guide shaft configured to guide movement of the first edge guide. The first edge guide includes a first contact section that can contact a first edge of the medium, a first locker formed with a first hole through which the first guide shaft passes, a second locker formed with a second hole through which the first guide shaft passes, and a first biasing section that biases the first locker and the second locker. The first locker and the second locker are biased by the first biasing section to tilt in different directions.

### CROSS-REFERENCE TO RELATED APPLICATIONS

The present application is based on, and claims priority from JP Application Serial Number 2024-105418, filed Jun. 28, 2024, and JP Application Serial Number 2025-046254, filed Mar. 21, 2025, the disclosures of which are hereby incorporated by reference herein in their entirety.

### BACKGROUND

### 1. Technical Field

The present disclosure relates to a medium placement device.

### 2. Related Art

For example, as in JP-A-2014-133630, there is a sheet feeding apparatus, which is an example of a medium placement device for supplying a sheet of paper, which is an example of a medium, to an image forming apparatus. The sheet feeding device includes a slide shaft, which is an example of a guide shaft, and a sheet feed fence, which is an example of an edge guide. The sheet feed fence aligns sheets by moving along the slide shaft.

The sheet feed fence includes a restricting member for locking the position. The restricting member is formed with a hole section into which the slide shaft is inserted. The inner edge of the hole section is angular. The restricting member suppresses movement of the sheet feed fence by pressing the inner edge section of the hole section toward the surface of the slide shaft.

In JP-A-2014-133630, the inner edge of the hole section is pressed against the slide shaft by tilting the restricting member. Therefore, of the directions along the slide shaft, the sheet feed fence is suppressed from moving against force in a direction in which the sheet feeding fence is tilted, but may move when force is applied in the opposite direction.

### SUMMARY

A medium placement device that overcomes the above problem includes a placement section configured to have a medium placed thereon; an edge guide configured to align an edge of the medium placed on the placement section; and a guide shaft configured to guide movement of the edge guide, wherein the edge guide includes a contact section configured to contact the edge of the medium, a first locker in which is formed a first hole through which the guide shaft passes, a second locker in which is formed a second hole through which the guide shaft passes, and a first biasing section configured to bias the first locker and the second locker and the first locker and the second locker are biased by the first biasing section to tilt in different directions from each other.

### BRIEF DESCRIPTION OF THE DRAWINGS

FIG. 1 is a schematic diagram of a first embodiment of a recording device including a medium placement device.

FIG. 2 is a rear view of a feed device.

FIG. 3 is a perspective view of the feed device.

FIG. 4 is a cross-sectional view taken along line 4-4 in FIG. 2.

FIG. 5 is a perspective view of the medium placement device.

FIG. 6 is a perspective view of a first edge guide and a second edge guide.

FIG. 7 is a schematic view of a first operation section.

FIG. 8 is a perspective view of a first locker and a second locker in a tilted posture.

FIG. 9 is a side view of the first locker and the second locker in the tilted posture.

FIG. 10 is a bottom view of the first locker and the second locker in the tilted posture.

FIG. 11 is a bottom view of the first locker and the second locker in a release posture.

FIG. 12 is a side view of the first locker and the second locker in the release posture.

FIG. 13 is a schematic view of a second operation section.

FIG. 14 is a perspective view of a third locker and a fourth locker in a tilted posture.

FIG. 15 is a bottom view of the third locker and the fourth locker in the tilted posture.

FIG. 16 is a bottom view of the third locker and the fourth locker in a release posture.

FIG. 17 is a perspective view of a feed device included in a recording device according to a second embodiment.

FIG. 18 is a schematic view of a medium placement device of the second embodiment.

FIG. 19 is an enlarged view of a second edge guide.

FIG. 20 is a cross-sectional view taken along the line F20-F20 in FIG. 19.

### DESCRIPTION OF EMBODIMENTS

### Embodiments of the Disclosure

### First Embodiment

Hereinafter, a first embodiment of a recording device including a medium placement device will be described with reference to the drawings. The recording device of the present embodiment is, for example, an ink jet printer that performs recording by discharging ink, which is an example of liquid, onto a medium such as a paper sheet.

In the drawings, assuming that a recording device 11 is placed on a horizontal surface, the direction of gravity is indicated by a Z-axis, and directions along the horizontal surface are indicated by an X-axis and a Y-axis. The X-axis, the Y-axis, and the Z-axis are orthogonal to each other. In the following description, a direction parallel to the X-axis is also referred to as a width direction X, and a direction parallel to the Z-axis is also referred to as a vertical direction Z.

### Recording Device

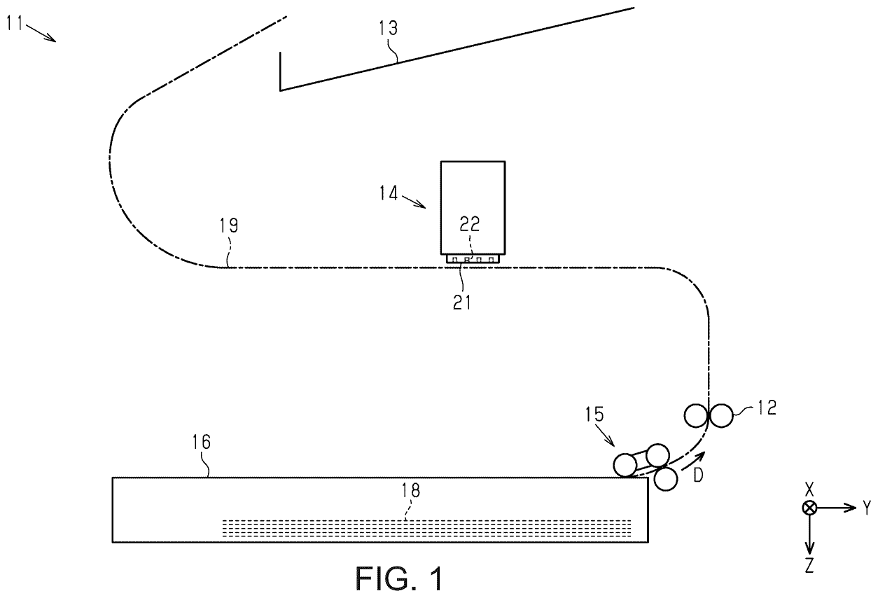

As shown in FIG. 1, the recording device 11 may include a transport section 12, a stacker 13, a recording section 14, a feed device 15, and a medium placement device 16. In FIG. 1, a transport path 19 along which the transport section 12 transports the medium 18 is indicated by dashed-dotted line.

The transport section 12 may include a pair of rollers. The transport section 12 may include a plurality of pairs of rollers. The transport section 12 may transport the medium 18 by sandwiching the medium 18 with a pair of rollers and rotating the rollers. The transport section 12 sends the medium 18 that was fed from the medium placement device 16 by the feed device 15 to the stacker 13.

The stacker 13 receives the medium 18 transported by the transport section 12. A plurality of recorded medium 18 can be stacked on the stacker 13.

The recording section 14 performs recording on the medium 18. The recording section 14 may include a nozzle surface 21. A plurality of nozzles 22 are opened in the nozzle surface 21. The recording section 14 performs recording on the transported medium 18 by discharging liquid from the nozzles 22.

### Feed Device

As shown in FIG. 1, the feed device 15 feeds the medium 18 accommodated in the medium placement device 16. “Feed” means to send out the medium 18 stacked on the medium placement device 16 one sheet at a time. The feed device 15 feeds, for example, the sheet of the medium 18 positioned at the top of the medium 18 set in the medium placement device 16 to the transport path 19. In the present embodiment, the direction in which the feed device 15 feeds the medium 18 is also referred to as the feed direction D.

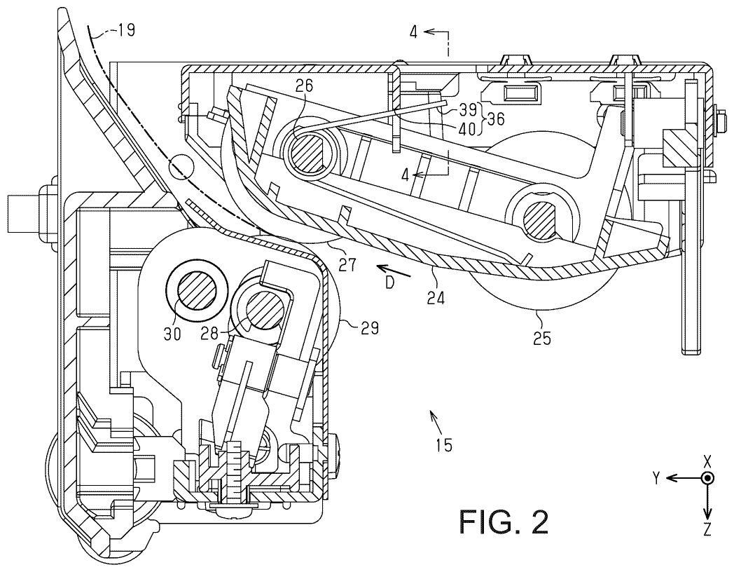

As shown in FIG. 2, the feed device 15 may include a holder 24, a pickup roller 25, a separation shaft 26, and a separation roller 27. The feed device 15 may include a retard shaft 28, a retard roller 29, and a drive shaft 30.

The holder 24 is rotatable centered on the separation shaft 26. The holder 24 moves the pickup roller 25 back and forth between a separated position shown in FIG. 2 and a pickup position (not shown). The separated position is a position where the medium placement device 16, which is attached to and detached from the recording device 11, and the pickup roller 25 do not interfere with each other. The pickup position is a position at which the medium 18 set in the medium placement device 16 and the pickup roller 25 contact each other in a state in which the medium placement device 16 is mounted on the recording device 11.

The pickup roller 25 feeds the medium 18 from the medium placement device 16 by rotating in the pickup position.

The separation roller 27 is rotatable centered on the separation shaft 26. The separation roller 27 is positioned downstream from the pickup roller 25 in the feed direction D. The separation roller 27 nips, between itself and the retard roller 29, the medium 18 that was sent by the pickup roller 25. The separation roller 27 rotates so as to feed the medium 18 in the feed direction D. Specifically, the separation roller 27 rotates in the clockwise direction in FIG. 2.

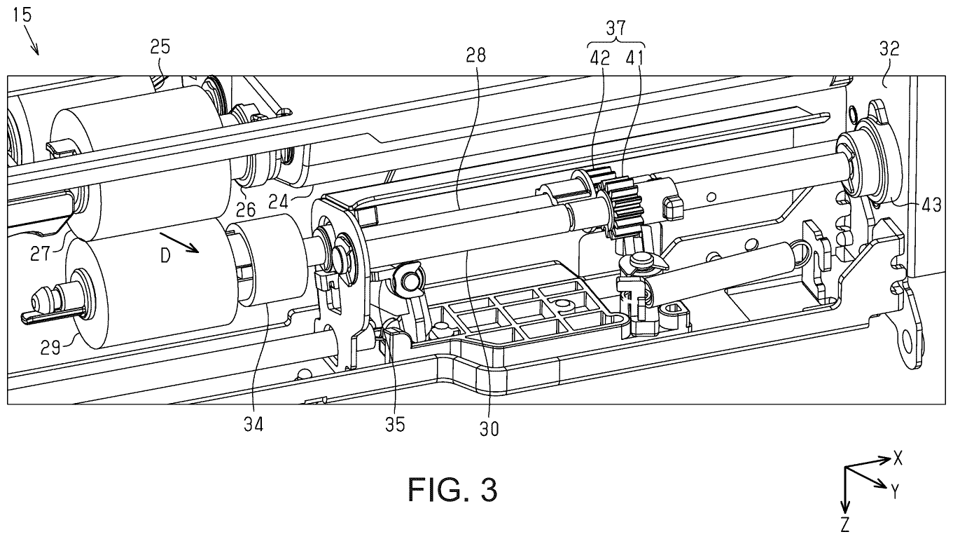

As shown in FIG. 3, the feed device 15 includes a frame 32. The retard shaft 28 may be supported by the frame 32 in a cantilever manner. The retard roller 29 is provided at the tip of the retard shaft 28.

The retard roller 29 may be rotatable in a forward rotation direction and in a reverse rotation direction. The forward rotation direction is a direction that returns the medium 18 to the medium placement device 16. The forward rotation direction is the clockwise direction in FIG. 2. The reverse rotation direction is a direction opposite from the forward rotation direction.

The separation roller 27 and the retard roller 29 separate the sheets of medium 18 transported by the pickup roller 25. When the separation roller 27 and the retard roller 29 sandwich between themselves plural sheets of the medium 18, the first sheet of medium 18 positioned at the top is sent in the feed direction D by the separation roller 27. At this time, the second and subsequent sheets of medium 18 are returned in the direction opposite to the feed direction D by the retard roller 29.

As shown in FIG. 3, the feed device 15 may include a torque limiter 34. The torque limiter 34 may be provided on the retard shaft 28. In other words, the retard shaft 28 supports the retard roller 29 via the torque limiter 34.

The torque limiter 34 interrupts transmission of drive force when the retard roller 29 receives a predetermined force in the reverse rotation direction. For example, in a case where the separation roller 27 and the retard roller 29 sandwich one sheet of the medium 18, the medium 18 is sent in the feed direction D by the separation roller 27. The retard roller 29 contacts the medium 18 fed in the feed direction D. That is, the retard roller 29 receives from the medium 18 a force in the reverse rotation direction. Therefore, the torque limiter 34 interrupts transmission of the drive force to the retard roller 29. The retard roller 29 may be rotated by the medium 18 transported in the feed direction D.

As shown in FIG. 3, the feed device 15 may include a load applying section 35. The load applying section 35 applies a load to the retard shaft 28. The load applying section 35 presses the retard roller 29 against the separation roller 27 by pressing the retard shaft 28.

The appropriate force applied to the medium 18 by the pickup roller 25, the separation roller 27 and the retard roller 29 varies depending on, for example, the type of the medium 18. The type of the medium 18 includes thickness, size, basis weight, and the like. For example, when a strong force is applied to a thin medium 18, the medium 18 may be twisted. For example, when a weak force is applied to the thick medium 18, the medium 18 may not be fed out.

The feed device 15 may include a first load adjustment section 36 illustrated in FIG. 2 and a second load adjustment section 37 illustrated in FIG. 3. The first load adjustment section 36 adjusts the force at which the pickup roller 25 presses the medium 18. The second load adjustment section 37 adjusts the force at which the retard roller 29 nips the medium 18 between itself and the separation roller 27. The first load adjustment section 36 and the second load adjustment section 37 adjust the load on the medium 18. The load may be adjusted in advance by an operator in accordance with the medium 18 handled by the recording device 11.

### First Load Adjustment Section

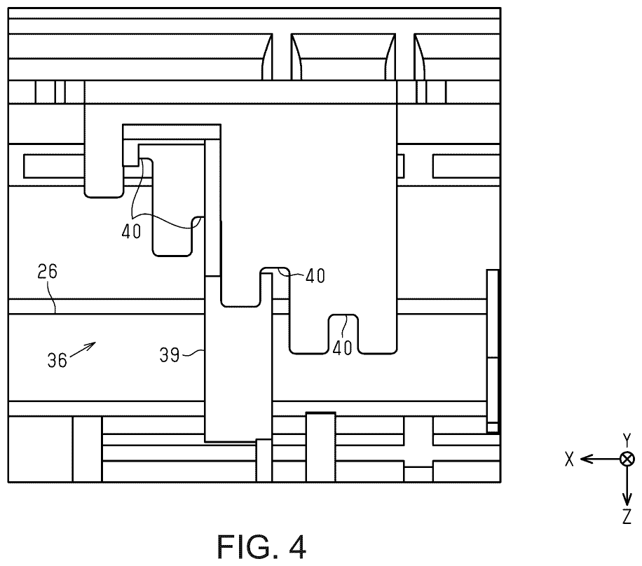

As shown in FIGS. 2 and 4, the first load adjustment section 36 includes a spring member 39 and a plurality of engagement sections 40.

The spring member 39 is, for example, a torsion coil spring. The spring member 39 may be attached to the separation shaft 26. One leg of the spring member 39 presses the holder 24. The other leg of the spring member 39 is engaged with an engagement section 40. The spring member 39 can engage with the plurality of engagement sections 40. The plurality of engagement sections 40 are at different positions in the circumferential direction around the separation shaft 26. Therefore, by changing the engagement section 40 with which the spring member 39 is engaged, the force at which the spring member 39 presses the holder 24 can be changed. The pickup roller 25 is provided on the holder 24. When the force of the spring member 39 pressing the holder 24 increases, the force of the pickup roller 25 pressing the medium 18 also increases.

### Second Load Adjustment Section

As shown in FIG. 3, the second load adjustment section 37 may include a drive gear 41, a driven gear 42, and a one-way clutch 43.

The drive gear 41 is provided on the drive shaft 30. The drive gear 41 rotates integrally with the drive shaft 30. The drive gear 41 transmits drive force to the driven gear 42.

The driven gear 42 is provided on the retard shaft 28. The driven gear 42 rotates integrally with the retard shaft 28. The driven gear 42 meshes with the drive gear 41.

The one-way clutch 43 may be provided on the drive shaft 30. The one-way clutch 43 transmits rotational in the forward rotation direction that was transmitted from a drive source (not shown) to the drive shaft 30, and blocks rotational force in the reverse rotation direction that was transmitted from the drive source.

When the drive shaft 30 rotates in the forward rotation direction, the retard roller 29 rotates in the forward rotation direction together with the drive gear 41, the driven gear 42, and the retard shaft 28. The drive gear 41 rotating in the forward rotation direction meshes with the driven gear 42 so as to push the driven gear 42 up from below. The retard roller 29 is positioned below the separation roller 27. Therefore, the force that the driven gear 42 receives from the drive gear 41 includes a force in a direction in which the retard roller 29 approaches the separation roller 27.

The positions of the drive gear 41 and the driven gear 42 in the axial direction of the retard shaft 28 can be adjusted. The drive gear 41 and the driven gear 42 are, for example, slidable with respect to the retard shaft 28 and the drive shaft 30 when lock is released. When the positions of the drive gear 41 and the driven gear 42 approach the retard roller 29, the force of the retard roller 29 pressing the separation roller 27 increases. When the drive gear 41 and the driven gear 42 are moved away from the retard roller 29, the force of the retard roller 29 pressing the separation roller 27 weakens.

### Medium Placement Device

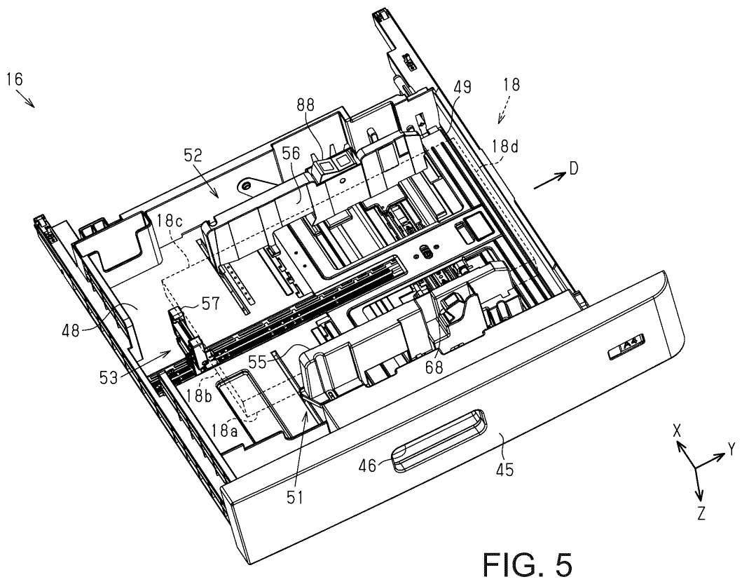

As shown in FIG. 5, the drawing shows the X-axis, the Y-axis, and the Z-axis in a posture in which the medium placement device 16 is mounted on the recording device 11. The medium placement device 16 may be mounted on the recording device 11 by being pushed in from the front surface of the recording device 11. The feed direction D in the medium placement device 16 is a direction parallel to the Y axis.

The medium placement device 16 may include a front wall 45. The front wall 45 may be provided with a pull section 46. The front wall 45 may be exposed to the outside in the state of being mounted on the recording device 11.

The user can pull out the medium placement device 16 by hooking his/her hand on the pull section 46. The medium placement device 16 may be possible to pull out from the recording device 11.

The medium placement device 16 can accommodate plural sheets of medium 18 in a stacked state. The medium placement device 16 may include a placement section 48 and a hopper 49.

The placement section 48 is configured to have placed thereon one or more sheets of the medium 18. “Place” means to put an object in the manner of placing the object. The placement section 48 of the present embodiment can support a bundle of plural sheets of medium 18 stacked on each other.

The hopper 49 lifts up at least a portion of the medium 18 placed on the placement section 48 in order to bring the medium 18 closer to the feed device 15.

The medium placement device 16 includes an edge guide. The medium placement device 16 may include a plurality of edge guides. The medium placement device 16 of the present embodiment includes a first edge guide 51 to a third edge guide 53. The first edge guide 51 to the third edge guide 53 align the edges of the medium 18 placed on the placement section 48. The edges of the medium 18 aligned by the first edge guide 51 to the third edge guide 53 may be different from each other.

In the present embodiment, it is assumed that a rectangular medium 18 is placed on the placement section 48, and the four linear edges of the medium 18 are referred to as a first edge 18a to a fourth edge 18d. It is preferable that the medium 18 be placed in a posture in which the first edge 18a and the third edge 18c are parallel to the Y-axis and a posture in which the second edge 18b and the fourth edge 18d are parallel to the X-axis. The first edge 18a is the edge close to the front wall 45.

The second edge 18b intersects the first edge 18a and the third edge 18c, and is an edge on the upstream side in the feed direction D. The third edge 18c is an edge opposite to the first edge 18a in the width direction X and is an edge located to the rear with respect to the front wall 45. The fourth edge 18d intersects the first edge 18a and the third edge 18c, and is an edge on the downstream side in the feed direction D.

The first edge guide 51 includes a first contact section 55, which is an example of a contact section. The first contact section 55 can contact the first edge 18a. The first edge guide 51 aligns the first edge 18a.

The second edge guide 52 includes a second contact section 56, which is an example of a contact section. The second contact section 56 can contact the third edge 18c. The second edge guide 52 aligns the third edge 18c.

The third edge guide 53 includes a third contact section 57, which is an example of a contact section. The third contact section 57 can contact the second edge 18b of the medium 18. The third edge guide 53 aligns the second edge 18b.

The first edge guide 51 is positioned between the second edge guide 52 and the front wall 45 in the width direction X. The distance from the pull section 46 to the first edge guide 51 is shorter than the distance from the pull section 46 to the second edge guide 52.

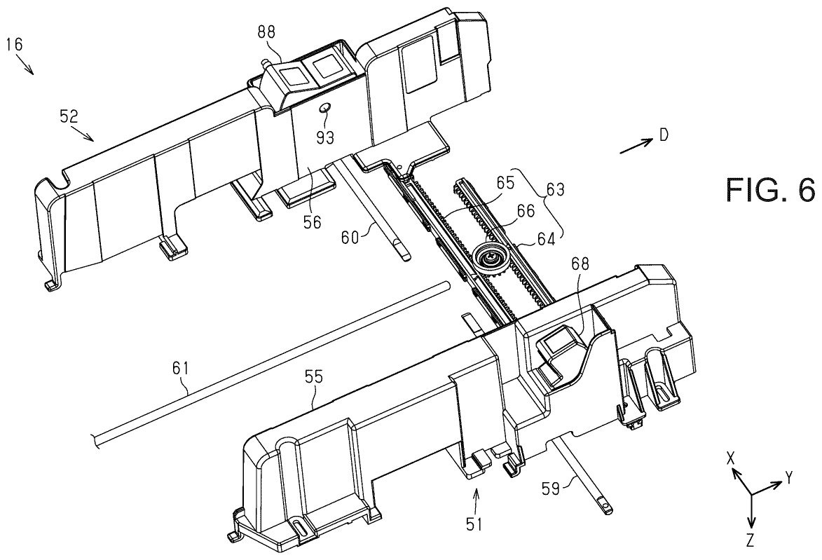

As shown in FIG. 6, the medium placement device 16 includes a guide shaft. The medium placement device 16 may include a plurality of guide shafts. The medium placement device 16 may include plural sets of edge guides and guide shafts. The medium placement device 16 of the present embodiment includes the first guide shaft 59 to the third guide shaft 61.

The first guide shaft 59 and the second guide shaft 60 extend in the width direction X. The first guide shaft 59 guides movement of the first edge guide 51. The first guide shaft 59 guides the first edge guide 51, which reciprocates in the width direction X. The second guide shaft 60 guides movement of the second edge guide 52. The second guide shaft 60 guides the second edge guide 52, which reciprocates in the width direction X.

The third guide shaft 61 extends in the feed direction D. The third guide shaft 61 guides movement of the third edge guide 53. The third guide shaft 61 guides the third edge guide 53, which reciprocates in the feed direction D. The third guide shaft 61 may extend to a position between the first guide shaft 59 and the second guide shaft 60.

The medium placement device 16 may include an interlocking section 63. The interlocking section 63 moves the second edge guide 52 in conjunction with the first edge guide 51 moving along the first guide shaft 59. The interlocking section 63 may include a first rack 64, a second rack 65, and a pinion 66.

The first rack 64 and the second rack 65 extend in the width direction X. The first rack 64 is attached to the first edge guide 51. The second rack 65 is attached to the second edge guide 52. The first rack 64 and the second rack 65 are engaged with the same pinion 66.

When one of the first edge guide 51 and the second edge guide 52 is moved, the other also moves. Specifically, the first edge guide 51 and the second edge guide 52 move so as to approach each other or to separate from each other.

### First Edge Guide

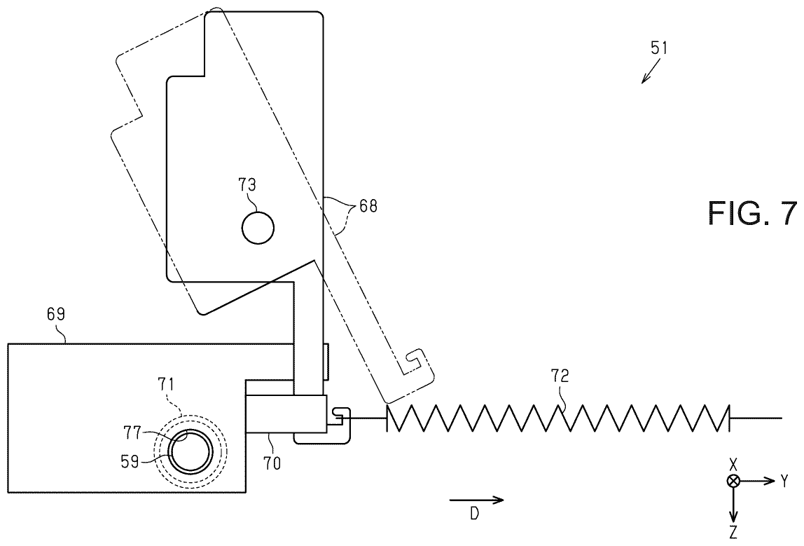

As shown in FIG. 7, the first edge guide 51 may include a first operation section 68, a first locker 69, a second locker 70, a first biasing section 71, and a second biasing section 72.

The first operation section 68, by rotating about the first operation shaft 73, can move between a release position indicated by solid line in FIG. 7 and a lock position indicated by two dot chain line in FIG. 7. The lock position of the first operation section 68 is also the position shown in FIG. 6. The first operation section 68 of the present embodiment has a lever shape.

The second biasing section 72 biases the first operation section 68. “Bias” means that when a force is applied to an object, the object is pushed back or pulled back against the force. The second biasing section 72 of the present embodiment is a tension spring. The second biasing section 72, for example, returns the first operation section 68 that was moved to the release position by the user, back to the lock position. The second biasing section 72 separates the first operation section 68 from the first locker 69 and the second locker 70.

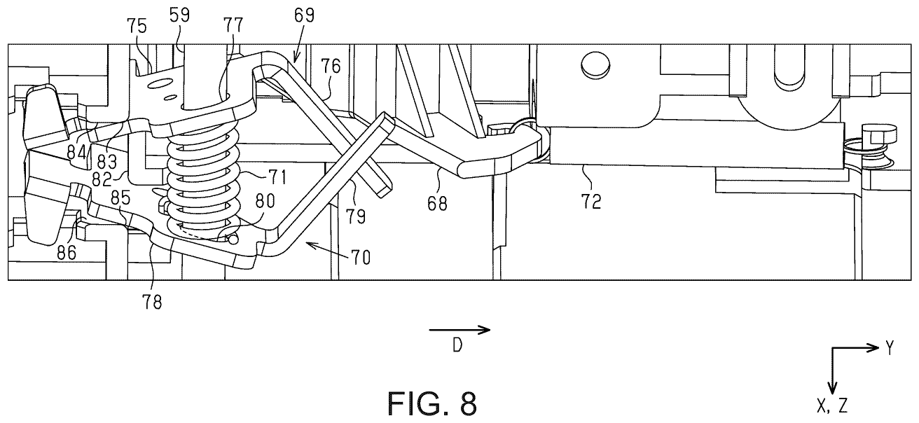

As shown in FIG. 8, the first locker 69 may include a first base section 75 and a first arm section 76. A first hole 77 is formed in the first locker 69. The first hole 77 may be formed in the first base section 75. The first hole 77 is larger than the first guide shaft 59. The first guide shaft 59 passes through the first hole 77. The first locker 69 can change its posture with respect to the first guide shaft 59 in a state where the first guide shaft 59 is inserted into the first hole 77.

The second locker 70 may include a second base section 78 and a second arm section 79. A second hole 80 is formed in the second locker 70. The second hole 80 may be formed in the second base section 78. The second hole 80 is larger than the first guide shaft 59. The first guide shaft 59 passes through the second hole 80. The second locker 70 can change its posture with respect to the first guide shaft 59 in a state where the first guide shaft 59 is inserted into the second hole 80.

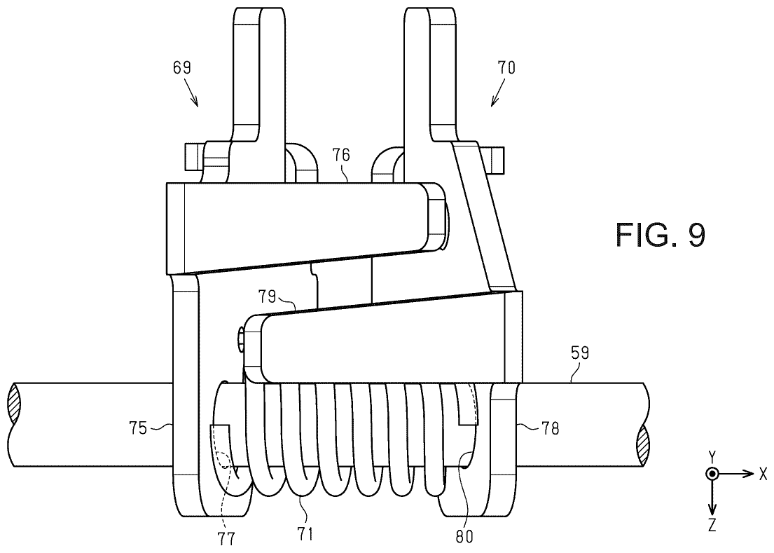

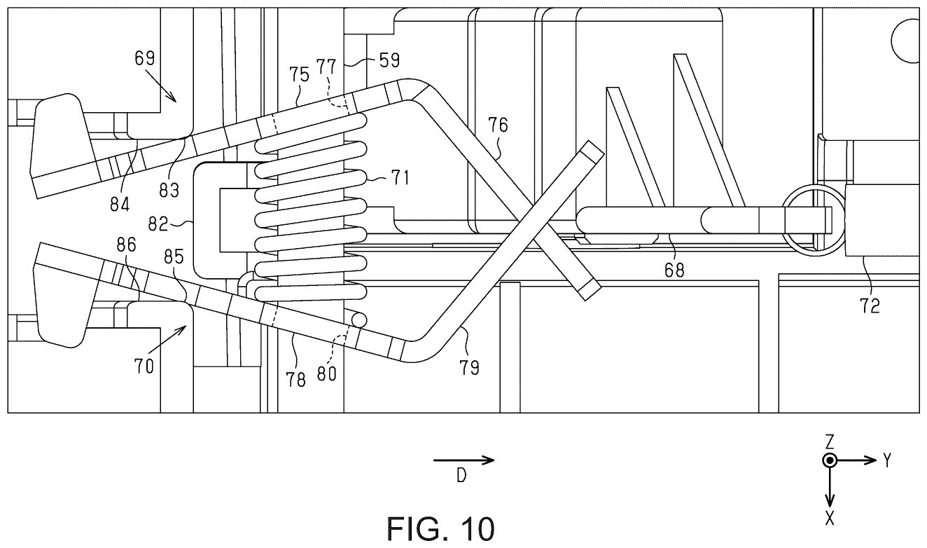

As shown in FIGS. 9 and 10, the first arm section 76 forms an obtuse angle with respect to the first base section 75 and extends to approach the second locker 70. The second arm section 79 forms an obtuse angle with respect to the second base section 78 and extends to approach the first locker 69. The second arm section 79 passes under the first arm section 76.

As shown in FIG. 10, when the first locker 69 and the second locker 70 are viewed from below, the first arm section 76 and the second arm section 79 intersect.

The first biasing section 71 biases the first locker 69 and the second locker 70. The first biasing section 71 of the present embodiment is a compression spring positioned between the first locker 69 and the second locker 70. The first biasing section 71 tilts the first locker 69 and the second locker 70 in different directions.

The tilted first locker 69 and second locker 70 take the tilted posture shown in FIGS. 8 to 10. When the first locker 69 is in the tilted posture, the edge of the first hole 77 contacts the first guide shaft 59.

When the second locker 70 is in the tilted posture, the edge of the second hole 80 contacts the first guide shaft 59. The first locker 69 and the second locker 70 in the tilted posture restrict movement in the width direction X with respect to the first guide shaft 59. The first locker 69 in the tilted posture restricts movement in the −X direction with respect to the first guide shaft 59. The second locker 70 in the tilted posture restricts movement in the +X direction with respect to the first guide shaft 59.

As shown in FIG. 10, the first edge guide 51 may include a first restriction section 82, which is an example of a restriction section, a first support section 83, a first stopper 84, a second support section 85, and a second stopper 86.

The first restriction section 82 is provided between the first locker 69 and the second locker 70. The first restriction section 82 may be provided between the first base section 75 and the second base section 78. The first restriction section 82 restricts the first base section 75 from approaching the second base section 78 and the second base section 78 from approaching the first base section 75. The first restriction section 82 may be located with respect to the feed direction D at a position that is between the first support section 83 and the first guide shaft 59 and that is also at a position between the second support section 85 and the first guide shaft 59.

The distance in the width direction X between the first support section 83 and the first restriction section 82 is larger than the thickness of the first locker 69. For example, the thickness of the first locker 69 is a distance from the inner surface where the first hole 77 is opened to the outer surface where the first hole 77 is opened. The first locker 69 can rotate about the first support section 83 as a fulcrum to change its posture.

The distance in the width direction X between the second support section 85 and the first restriction section 82 is larger than the thickness of the second locker 70. For example, the thickness of the second locker 70 is a distance from the inner surface where the second hole 80 is opened to the outer surface where the second hole 80 is opened. The second locker 70 can rotate about the second support section 85 as a fulcrum to change its posture.

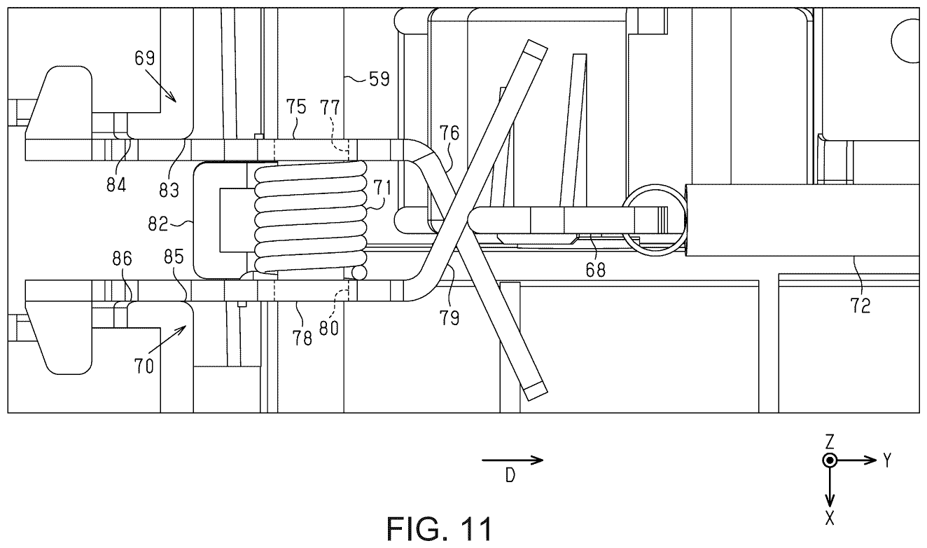

As shown in FIG. 11, the first operation section 68 can change the postures of the first locker 69 and the second locker 70 to the release posture. The first operation section 68 moving from the lock position to the release position changes the first locker 69 and the second locker 70 from the tilted posture to the release posture. The first operation section 68 contacts the first arm section 76 and the second arm section 79 between the first base section 75 and the second base section 78 with respect to the axial direction of the first guide shaft 59. The first operation section 68 changes the first locker 69 and the second locker 70 to the release posture by pushing the first arm section 76 and the second arm section 79, which intersect each other, so they approach the first guide shaft 59.

The first operation section 68 changes the postures of the first locker 69 and the second locker 70 against the biasing force of the first biasing section 71. Specifically, the first operation section 68 changes the first locker 69 and the second locker 70 in the tilted posture to the release posture by pushing the first locker 69 and the second locker 70 against the biasing force of the first biasing section 71.

The first stopper 84 contacts the first locker 69 that was changed from the tilted posture to the release posture. The first stopper 84 causes the first locker 69 to take the release posture by restricting rotation of the first locker 69.

The second stopper 86 contacts the second locker 70 that was changed from the tilted posture to the release posture. The second stopper 86 causes the second locker 70 to take the release posture by restricting rotation of the second locker 70.

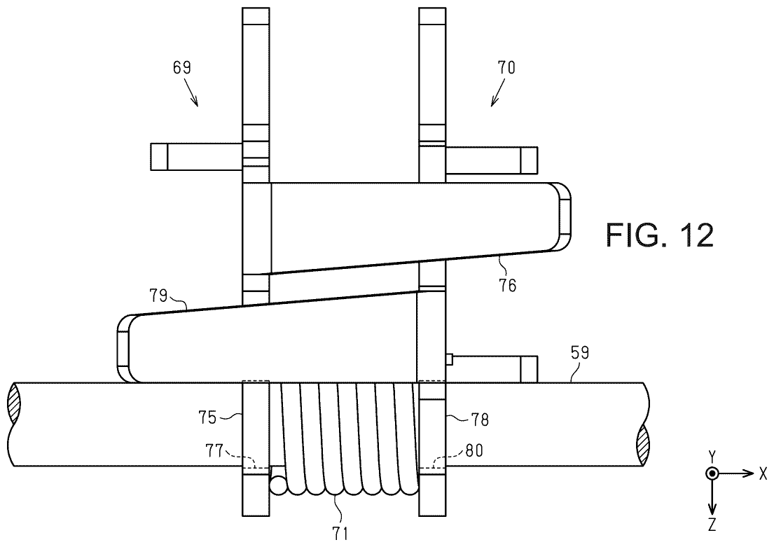

As shown in FIGS. 11 and 12, when the first locker 69 is in the release posture, the edge of the first hole 77 is separated from the first guide shaft 59. The first base section 75 may be perpendicular to the first guide shaft 59 when the first locker 69 is in the release posture. The inner surface of the first hole 77 may be parallel to the outer surface of the first guide shaft 59 when the first locker 69 is in the release posture. The inner surface of the first hole 77 may contact the outer surface of the first guide shaft 59 in parallel when the first locker 69 is in the release posture.

The edge of the second hole 80 separates from the first guide shaft 59 when the second locker 70 is in the release posture. The second base section 78 may be perpendicular to the first guide shaft 59 when the second locker 70 is in the release posture. The second locker 70 may be such that in the release posture, the inner surface of the second hole 80 is parallel to the outer surface of the first guide shaft 59. The inner surface of the second hole 80 may contact in parallel with the outer surface of the first guide shaft 59 when the second locker 70 is in the release posture. The first locker 69 and the second locker 70 release the restriction of movement of the first edge guide 51 by being in the release posture.

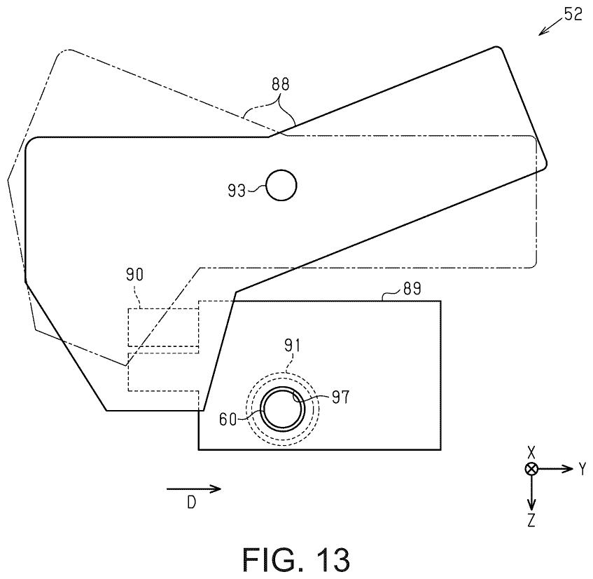

As shown in FIG. 13, the second edge guide 52 may include a second operation section 88, a third locker 89, which is also an example of the first locker, a fourth locker 90, which is also an example of the second locker, and a third biasing section 91, which is also an example of a first biasing section.

The second operation section 88 can move between a release position indicated by solid line in FIG. 13 and a lock position indicated by two dot chain line in FIG. 13 by rotating about the second operation shaft 93. The lock position of the second operation section 88 is also the position shown in FIG. 6. The second operation section 88 is in the form of a switch. The user positions the second operation section 88 into the lock position by pressing one side of the second operation section 88, and positions the second operation section 88 into the release position by pressing the other side of the second operation section 88.

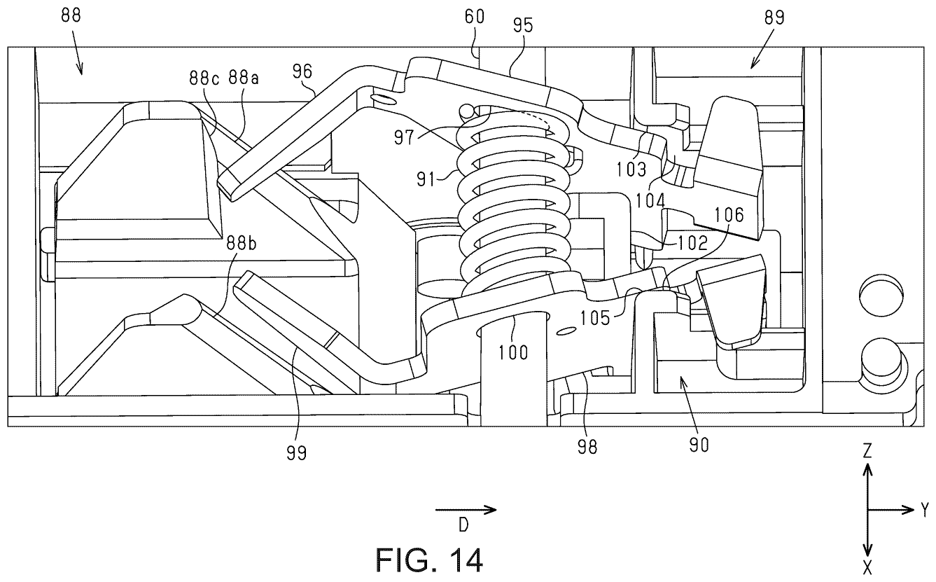

As shown in FIG. 14, the second operation section 88 may include a first wall section 88a, a second wall section 88b, and a first protruding section 88c. The first wall section 88a and the second wall section 88b are provided with a space therebetween in the width direction X. The first protruding section 88c may be provided on the first wall section 88a. The first protruding section 88c protrudes from the inner surface of the first wall section 88a, which faces the second wall section 88b, toward the second wall section 88b. The second wall section 88b may be provided with a protruding section that protrudes from an inner surface of the second wall section 88b, which faces the first wall section 88a, toward the first wall section 88a.

The third locker 89 may include a third base section 95 and a third arm section 96. A third hole 97 is formed in the third locker 89. The third hole 97 may be formed in the third base section 95. The third hole 97 is larger than the second guide shaft 60. The second guide shaft 60 passes through the third hole 97. The third locker 89 can change its posture with respect to the second guide shaft 60 in a state where the second guide shaft 60 is inserted through the third hole 97.

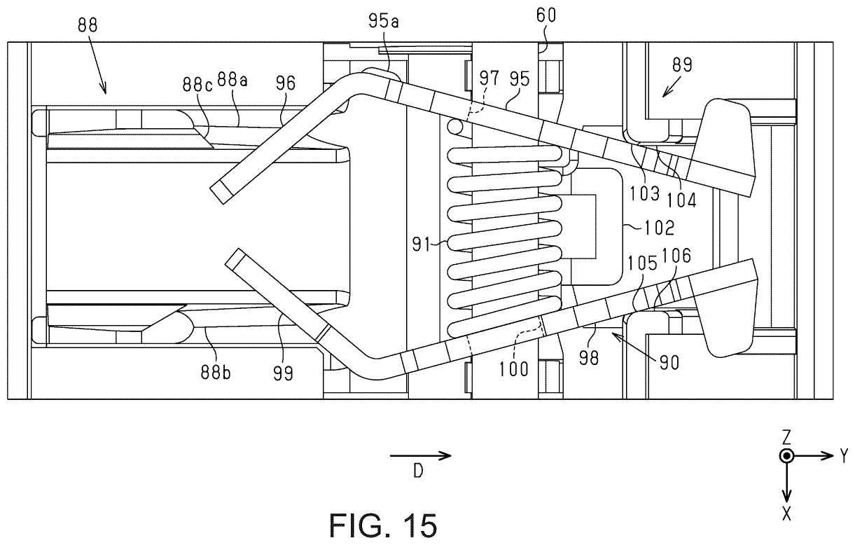

As shown in FIG. 15, the third base section 95 may have a second protruding section 95a. The second protruding section 95a protrudes from the outer surface on the opposite side than the fourth locker 90 side.

The fourth locker 90 may include a fourth base section 98 and a fourth arm section 99. A fourth hole 100 is formed in the fourth locker 90. The fourth hole 100 may be formed in the fourth base section 98. The fourth hole 100 is larger than the second guide shaft 60. The second guide shaft 60 passes through the fourth hole 100. The fourth locker 90 can change its posture with respect to the second guide shaft 60 in a state where the second guide shaft 60 is inserted through the fourth hole 100.

The third arm section 96 forms an obtuse angle with respect to the third base section 95 and extends to approach the fourth locker 90. The fourth arm section 99 forms obtuse angle with respect to the fourth base section 98 and extends to approach the third locker 89.

The third biasing section 91 biases the third locker 89 and the fourth locker 90. The third biasing section 91 of the present embodiment is a compression spring positioned between the third locker 89 and the fourth locker 90. The third biasing section 91 tilts the third locker 89 and the fourth locker 90 in different directions.

The tilted third locker 89 and fourth locker 90 take the tilted posture shown in FIGS. 14 and 15. The third locker 89 is such that in the tilted posture, the edge of the third hole 97 contacts the second guide shaft 60. The fourth locker 90 is such that in the tilted posture, the edge of the fourth hole 100 contacts the second guide shaft 60.

The third locker 89 and the fourth locker 90 in the tilted posture restrict movement in the width direction X with respect to the second guide shaft 60. The third locker 89 in the tilted posture restricts movement in the −X direction with respect to the second guide shaft 60. The fourth locker 90 in the tilted posture restricts movement in the +X direction with respect to the second guide shaft 60.

The second edge guide 52 may include a second restriction section 102, a third support section 103, a third stopper 104, a fourth support section 105, and a fourth stopper 106. The second restriction section 102 is an example of a restriction section. The third support section 103 is an example of a first support section. The third stopper 104 is an example of a first stopper. The fourth support section 105 is an example of a second support section. The fourth stopper 106 is an example of a second stopper.

The second restriction section 102 is provided between the third locker 89 and the fourth locker 90. The second restriction section 102 may be provided between the third base section 95 and the fourth base section 98. The second restriction section 102 restricts the third base section 95 from approaching the fourth base section 98 and the fourth base section 98 from approaching the third base section 95. The second restriction section 102 is located at a position between the third support section 103 and the second guide shaft 60 and at a position between the fourth support section 105 and the second guide shaft 60 with respect to the feed direction D.

The distance between the third support section 103 and the second restriction section 102 in the width direction X is larger than the thickness of the third locker 89. For example, the thickness of the third locker 89 is a distance from the inner surface where the third hole 97 is opened to the outer surface where the third hole 97 is opened. The third locker 89 can change its posture by rotating about the third support section 103 as a fulcrum.

The distance between the fourth support section 105 and the second restriction section 102 in the width direction X is larger than the thickness of the fourth locker 90. For example, the thickness of the fourth locker 90 is a distance from the inner surface where the fourth hole 100 is opened to the outer surface where the fourth hole 100 is opened. The fourth locker 90 can change its posture by rotating about the fourth support section 105 as a fulcrum.

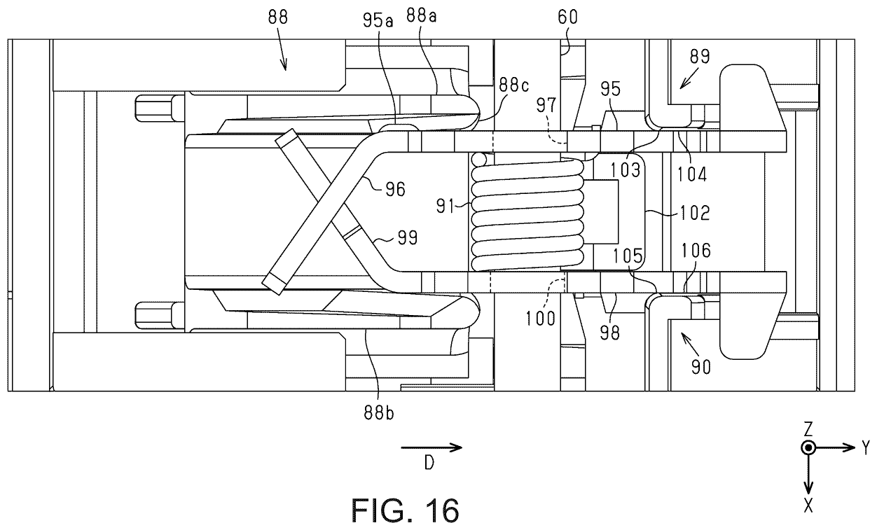

As shown in FIG. 16, the second operation section 88 can change the postures of the third locker 89 and the fourth locker 90 to the release posture. The second operation section 88 moving from the lock position to the release position changes the third locker 89 and the fourth locker 90 from the tilted posture to the release posture.

The second operation section 88 changes the postures of the third locker 89 and the fourth locker 90 against the biasing force of the third biasing section 91. Specifically, the second operation section 88 changes the third locker 89 and the fourth locker 90 in the tilted posture to the release posture by pushing the third locker 89 and the fourth locker 90 against the biasing force of the third biasing section 91. The second operation section 88 at the release position may sandwich the third locker 89 and the fourth locker 90 between the first wall section 88a and the second wall section 88b.

The second protruding section 95a may ride over the first protruding section 88c in the process of changing the third locker 89 from the tilted posture to the release posture. The second operation section 88 can maintain the third locker 89 and the fourth locker 90 in the release posture.

The third stopper 104 contacts the third locker 89 changed from the tilted posture to the release posture. The third stopper 104 causes the third locker 89 to take the release posture by restricting rotation of the third locker 89.

The fourth stopper 106 contacts the fourth locker 90 that was changed from the tilted posture to the release posture. The fourth stopper 106 causes the fourth locker 90 to take the release posture by restricting the rotation of the fourth locker 90.

The third locker 89 is such that in the release posture, the edge of the third hole 97 is separated from the second guide shaft 60. The third locker 89 may be such that in the release posture, the third base section 95 may be perpendicular to the second guide shaft 60. The third locker 89 may be such that in the release posture, the inner surface of the third hole 97 is parallel to the outer surface of the second guide shaft 60. The third locker 89 may be such that in the release posture, the inner surface of the third hole 97 contacts the outer surface of the second guide shaft 60 in parallel.

The fourth locker 90 may be such that in the release posture, the edge of the fourth hole 100 is separated from the second guide shaft 60.

The fourth locker 90 may be such that in the release posture, the fourth base section 98 is perpendicular to the second guide shaft 60. The fourth locker 90 may be such that in the release posture, the inner surface of the fourth hole 100 is parallel to the outer surface of the second guide shaft 60. The fourth locker 90 may be such that in the release posture, the inner surface of the fourth hole 100 contacts the outer surface of the second guide shaft 60 in parallel. The third locker 89 and the fourth locker 90 release the restriction of movement of the second edge guide 52 by being in the release posture.

### Third Edge Guide

The third edge guide 53 of the present embodiment has the same configuration as the first edge guide 51. The third guide shaft 61 passes through the first locker 69 and the second locker 70. The first locker 69 and the second locker 70 in the tilted posture restrict movement with respect to the third guide shaft 61. The first locker 69 and the second locker 70 release the restriction of movement of the third edge guide 53 by being in the release posture.

### Operation of the Present Embodiment

The operation of the present embodiment will be explained.

When the medium 18 placed on the placement section 48 is to be aligned, the user may first move the second operation section 88 to the release position. When the second operation section 88 is positioned at the release position, the second edge guide 52 becomes movable. Even when the user releases his/her hand from the second operation section 88, the second operation section 88 is held at the release position, and the movable state of the second edge guide 52 is maintained.

Subsequently, the user may move the first operation section 68 to the release position. When the first operation section 68 is positioned at the release position, the first edge guide 51 becomes movable. When the user moves the first edge guide 51 in a state where the first operation section 68 is positioned at the release position, the interlocking section 63 moves the second edge guide 52 in accordance with movement of the first edge guide 51.

The first edge guide 51 and the second edge guide 52 align the medium 18 by sandwiching the medium 18 in the width direction X.

When the user releases the first operation section 68, the first operation section 68 returns to the lock position. Therefore, movement of the first edge guide 51 is restricted. The user may restrict movement of the second edge guide 52 by moving the second operation section 88 to the lock position. The user may move the third edge guide 53 to a position where the third edge guide 53 contacts the medium 18.

The first edge guide 51, the second edge guide 52, and the third edge guide 53 are restricted from moving in both directions with respect to the corresponding guide shafts. Therefore, for example, it is possible to suppress deviation of the medium 18 against impact when the medium placement device 16 is mounted on the recording device 11 and the like.

### Effects of the Present Embodiment

Effects of the present embodiment will be described.

(1-1) The first locker 69 and the second locker 70 are tilted in opposite directions to each other in a state where the first guide shaft 59 is inserted. Therefore, movement of the first edge guide 51 in both directions with respect to the first guide shaft 59 can be suppressed.

(1-2) The first biasing section 71 is positioned between the first locker 69 and the second locker 70. The first biasing section 71 is a spring. The first biasing section 71 can tilt the first locker 69 and the second locker 70 in different directions by pushing the first locker 69 and the second locker 70 so as to separate from each other.

(1-3) The first operation section 68 can change the posture of the first locker 69 and the second locker 70 from the tilted posture to the release posture. By setting the first locker 69 and the second locker 70 to the release posture, the restriction of movement of the first edge guide 51 can be released.

(1-4) The first operation section 68 contacts the first arm section 76 and the second arm section 79 at a position between the first base section 75 and the second base section 78. Therefore, the postures of the first locker 69 and the second locker 70 can be changed by the single first operation section 68.

(1-5) The first operation section 68 changes the first locker 69 and the second locker 70 to the release posture by pressing the intersecting first arm section 76 and second arm section 79. Therefore, movement restriction of the first edge guide 51 can be released by a simple operation.

(1-6) The first operation section 68 is separated from the first locker 69 and the second locker 70 by being biased by the second biasing section 72. Therefore, the states of the first locker 69 and the second locker 70 can be easily determined from the position of the first operation section 68.

(1-7) The first restriction section 82 restricts the first base section 75 and the second base section 78 from approaching each other. Therefore, even when a force is applied to the first arm section 76 and the second arm section 79 and the postures of the first locker 69 and the second locker 70 are changed, it is possible to suppress deformation of the first base section 75 and the second base section 78.

(1-8) The first restriction section 82 is positioned between the first support section 83 and the first guide shaft 59.

The first restriction section 82 is positioned between the second support section 85 and the first guide shaft 59. Therefore, the first restriction section 82 can efficiently suppress deformation of the first locker 69 and the second locker 70.

(1-9) The distance between the first support section 83 and the first restriction section 82 is greater than the thickness of the first locker 69. Therefore, rotation of the first locker 69 about the first support section 83 as a fulcrum can occur between the first support section 83 and the first restriction section 82. The distance between the second support section 85 and the first restriction section 82 is larger than the thickness of the second locker 70. Therefore, rotation of the second locker 70 about the second support section 85 as a fulcrum can occur between the second support section 85 and the first restriction section 82.

(1-10) The second operation section 88 maintains the postures of the third locker 89 and the fourth locker 90 in the release posture. Therefore, the second edge guide 52 can be maintained in a state where restriction of movement is released.

(1-11) The first stopper 84 contacts the first locker 69 in the release posture. The second stopper 86 contacts the second locker 70 in the release posture. Therefore, the postures of the first locker 69 and the second locker 70 can be easily determined.

(1-12) The third edge guide 53 aligns the second edge 18b on the upstream side of the medium 18 in the feed direction D. Therefore, it is possible to easily and accurately feed the medium 18 from the medium placement device 16.

(1-13) The interlocking section 63 moves the second edge guide 52 in conjunction with movement of the first edge guide 51. Therefore, by restricting movement of the first edge guide 51, movement of the second edge guide 52 can be restricted. Therefore, both edges of the medium 18 in the width direction X can be aligned with a simple configuration.

(1-14) The medium placement device 16 is provided with the pull section 46. For example, when the medium placement device 16 is attached to or detached from another device, the user can easily perform the operation by hooking his/her hand on the pull section 46. The first edge guide 51 is provided at a position close to the pull section 46.

Therefore, movement restriction of the first edge guide 51 can be easily released.

(1-15) The first edge guide 51 and the second edge guide 52 align the first edge 18a and the third edge 18c of the medium 18, respectively. Both edges of the medium 18 in the width direction X can be aligned by the first edge guide 51, whose movement is suppressed by the first locker 69 and the second locker 70, and the second edge guide 52, whose movement is limited by the third locker 89 and the fourth locker 90.

(1-16) The restriction of movement of the first edge guide 51 is released by operating the first operation section 68. The restriction of movement of the second edge guide 52 is released by operating the second operation section 88. Therefore, both edges of the medium 18 in the width direction X can be aligned.

(1-17) The second operation section 88 can maintain the second edge guide 52 in a movable state. When the first edge guide 51 is moved with the second edge guide 52 in the movable state, the interlocking section 63 moves the second edge guide 52. Therefore, the second edge guide 52 can be easily moved by moving the first edge guide 51, which is close to the pull section 46.

(1-18) The first edge guide 51 and the third edge guide 53 align the first edge 18a and the second edge 18b of the medium 18, respectively. The medium 18 can be aligned in a plurality of directions by the first edge guide 51 and the third edge guide 53, whose movement is suppressed by the first locker 69 and the second locker 70.

### Second Embodiment

### Feed Device

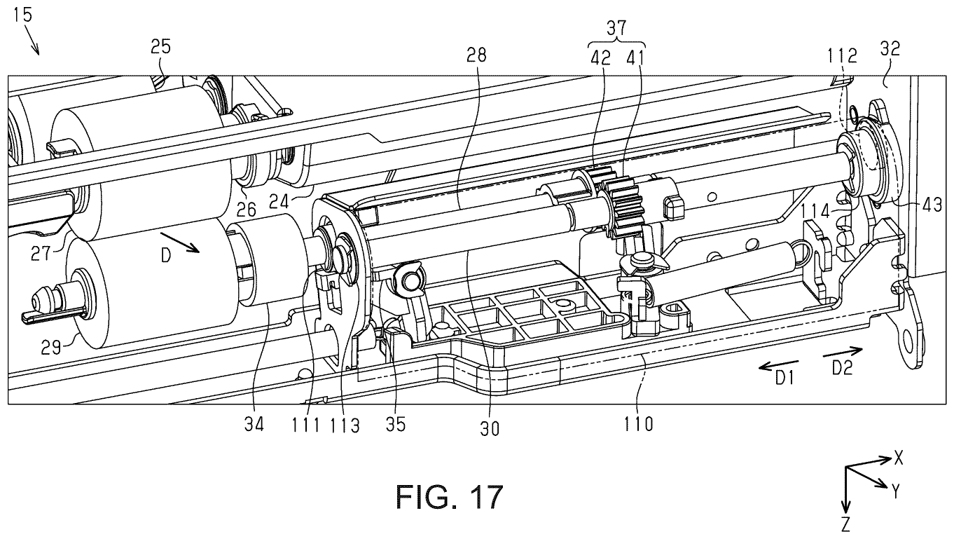

As shown in FIG. 17, the feed device 15 may include a cover section 110. The cover section 110 may be attached to the frame 32. The cover section 110 may be detachable from the frame 32. The cover section 110 may cover the driven gear 42 and the drive gear 41.

The retard shaft 28 and the drive shaft 30 extend parallel to each other. In the present embodiment, directions parallel to the retard shaft 28 and the drive shaft 30 are also referred to as a first direction D1 and a second direction D2. The second direction D2 is opposite from the first direction D1. The first direction D1 and the second direction D2 are also axial directions of the retard shaft 28 and the drive shaft 30.

The feed device 15 may include a first bearing 111, a second bearing 112, a third bearing 113, and a fourth bearing 114. The first bearing 111 to the fourth bearing 114 may be supported by the frame 32.

The first bearing 111 and the second bearing 112 rotatably support the retard shaft 28. The first bearing 111 is positioned in the first direction D1 from the driven gear 42. The second bearing 112 is positioned in the second direction D2 from the driven gear 42. The first bearing 111 and the second bearing 112 are provided on both sides of the driven gear 42 in the axial direction of the retard shaft 28. The outer diameter of the first bearing 111 may be larger than the outer diameter of the second bearing 112. The outer diameter of the second bearing 112 may be smaller than the outer diameter of the fourth bearing 114. The retard shaft 28 may have a diameter at the portion supported by the first bearing 111 larger than the diameter at the portion supported by the second bearing 112.

The first bearing 111 and the fourth bearing 114 may have the same outer diameter. The first bearing 111 may have an outer diameter larger or smaller than that of the fourth bearing 114. The second bearing 112 and the third bearing 113 may have the same outer diameter. The second bearing 112 may have a larger or smaller outer diameter than the third bearing 113.

The third bearing 113 and the fourth bearing 114 rotatably support the drive shaft 30. The third bearing 113 is positioned in the first direction D1 from the drive gear 41. The fourth bearing 114 is positioned in the second direction D2 from the drive gear 41. The third bearing 113 and the fourth bearing 114 are provided on either side of the drive gear 41 in the axial direction of the drive shaft 30. The outer diameter of the fourth bearing 114 may be larger than the outer diameter of the third bearing 113. The outer diameter of the third bearing 113 may be smaller than the outer diameter of the first bearing 111. The drive shaft 30 may have a larger diameter at a portion supported by the fourth bearing 114 than at a portion supported by the third bearing 113.

### Medium Placement Device

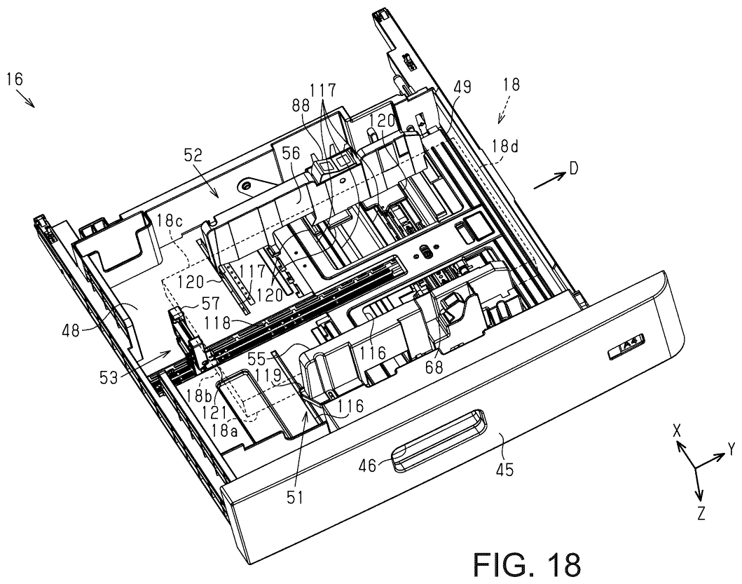

As shown in FIG. 18, the medium placement device 16 may include one or more guide rails. The medium placement device 16 may include a plurality of guide rails. The medium placement device 16 may include plural sets of edge guides and guide rails. The medium placement device 16 may be provided with a plurality of guide rails for a single edge guide. The medium placement device 16 of the embodiment includes one or more first guide rails 116, one or more second guide rails 117, and one or more third guide rails 118. The first edge guide 51 may include one or more first leg sections 119. The second edge guide 52 may include one or more second leg sections 120. The third edge guide 53 may include one or more third leg sections 121.

The first guide rail 116 extends in the width direction X. The first leg section 119 may be positioned within the first guide rail 116. The first leg section 119 is guided by the first guide rail 116.

The first guide rail 116 suppresses tilt of the first edge guide 51 with respect to the feed direction D.

The second guide rail 117 extends in the width direction X. The second leg section 120 may be positioned within the second guide rail 117. The second leg section 120 is guided by the second guide rail 117.

The second guide rail 117 suppresses tilt of the second edge guide 52 with respect to the feed direction D.

The third guide rail 118 extends in the feed direction D. The third leg section 121 may be positioned within the third guide rail 118. The third leg section 121 is guided by the third guide rail 118. The third guide rail 118 suppresses tilt of the third edge guide 53 with respect to the width direction X.

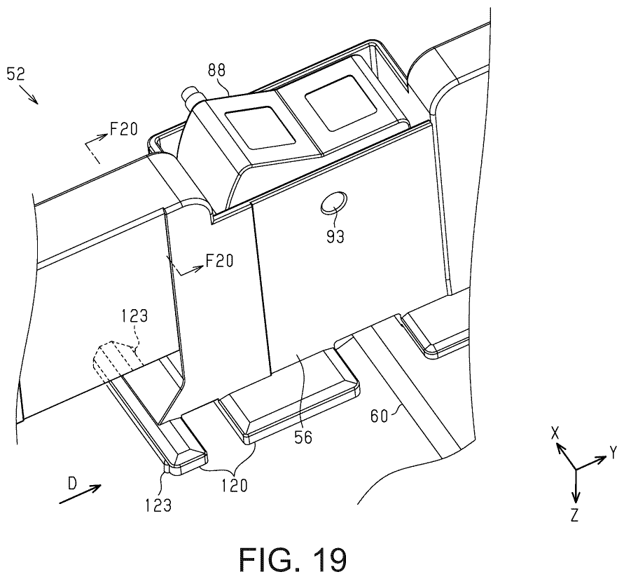

As shown in FIG. 19, at least one of the first leg section 119, the second leg section 120, and the third leg section 121 may have one or more protrusion sections 123. In the present embodiment, a single second leg section 120 located upstream of the second guide shaft 60 in the feed direction D includes two protrusion sections 123. The two protrusion sections 123 may be provided at diagonal positions on the second leg section 120. The two protrusion sections 123 may be provided to the inner side and to the outer side of the second contact section 56. The inner side of the second contact section 56 is the first edge guide 51 side. The outer side of the second contact section 56 is the opposite side to the first edge guide 51. The protrusion section 123 on the inner side of the second contact section 56 may be positioned upstream in the feed direction D with respect to the protrusion section 123 on the outer side. By providing the protrusion section 123, rattling of the second leg section 120 with respect to the second guide rail 117 can be reduced.

### First Edge Guide

The configuration of the first edge guide 51 is the same as that of the first embodiment. As shown in FIG. 10, the first edge guide 51 includes the first locker 69 and the second locker 70.

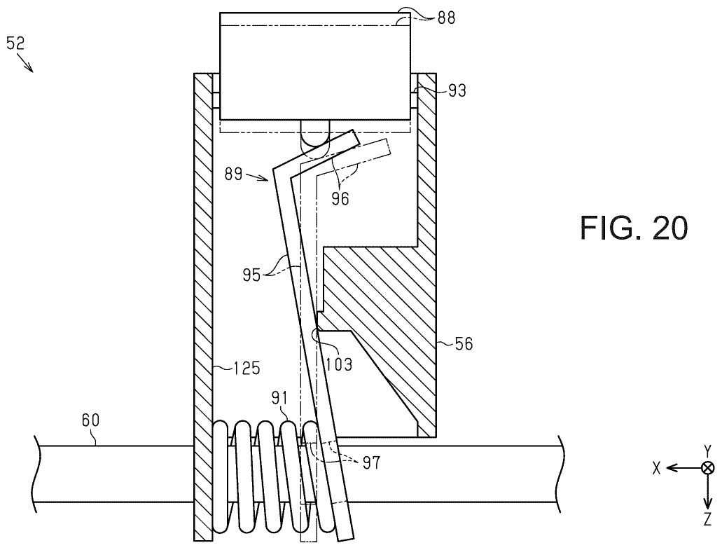

As shown in FIG. 20, the second edge guide 52 includes the third locker 89, and does not include the fourth locker 90. In other words, the second edge guide 52 includes one of the third locker 89 and the fourth locker 90. The second edge guide 52 may include the second contact section 56, the second operation section 88, the third locker 89, and the third biasing section 91. The second edge guide 52 may include the third support section 103 and an inner wall 125.

The second operation section 88 can be moved between a release position indicated by two dot chain line in FIG. 20 and a lock position indicated by solid line in FIG. 20 by rotating centered about the second operation shaft 93.

The third locker 89 may include a third base section 95 and a third arm section 96. The third base section 95 and the third arm section 96 may be flat plate-shaped. The third hole 97 is formed in the third locker 89. The third hole 97 may be formed in the third base section 95. The third hole 97 is larger than the second guide shaft 60. The second guide shaft 60 passes through the third hole 97. The third locker 89 can change its posture with respect to the second guide shaft 60 in a state where the second guide shaft 60 is inserted through the third hole 97.

The third arm section 96 forms an obtuse angle with respect to the third base section 95 and extends to approach the second contact section 56. The third arm section 96 is located above the third base section 95 in the vertical direction Z.

The third biasing section 91 biases the third locker 89. The third biasing section 91 of the present embodiment is a compression spring located between the third locker 89 and the inner wall 125. The third biasing section 91 tilts the third locker 89 in a direction in which the lower end of the third locker 89 separates from the inner wall 125. The third biasing section 91 tilts the third locker 89 so that the lower end of the third locker 89 approaches the second contact section 56.

The tilted third locker 89 takes the tilted posture shown by solid line in FIG. 20. The third locker 89 is such that in the tilted posture, the third hole 97 is located at a position closer to the second contact section 56 than the portion where the third base section 95 and the third arm section 96 intersect. The third locker 89 is such that in the tilted posture, the edge of the third hole 97 contacts the second guide shaft 60. The third locker 89 in the tilted posture restricts movement in the width direction X with respect to the second guide shaft 60. The third locker 89 restricts displacement of the second edge guide 52 in a direction that separates it from the first edge guide 51.

The third support section 103 is positioned above the second guide shaft 60 in the vertical direction Z. The third support section 103 may be provided on a wall on the back side of the second contact section 56. The third support section 103 may be positioned between the third locker 89 and the second contact section 56 in the width direction X. The third locker 89 can change its posture by rotating about the third support section 103 as a fulcrum.

The second operation section 88 can change the posture of the third locker 89 to the release posture indicated by two dot chain line in FIG. 20. The second operation section 88 moving from the lock position to the release position changes the third locker 89 from the tilted posture to the release posture. The second operation section 88 changes the posture of the third locker 89 against the biasing force of the third biasing section 91. Specifically, the second operation section 88 changes the third locker 89 from the tilted posture to the release posture by pushing the third locker 89 against the biasing force of the third biasing section 91.

In the tilted posture, plural sections of the edge of the third hole 97 along the vertical direction Z contact the second guide shaft 60. The edge of the third hole 97 may contact against the upper end and the lower end of the second guide shaft 60. The third hole 97 is formed such that the section that contacts the upper end of the second guide shaft 60 and the section that contacts the lower end of the second guide shaft 60 are shifted in the vertical direction Z.

The third locker 89 is such that in the release posture, the edge of the third hole 97 is separated from the second guide shaft 60. The third locker 89 may be such that in the release posture, the third base section 95 may be perpendicular to the second guide shaft 60. The third locker 89 may be such that in the release posture, the inner surface of the third hole 97 is parallel to the outer surface of the second guide shaft 60. The third locker 89 may be such that in the release posture, the inner surface of the third hole 97 contacts the outer surface of the second guide shaft 60 in parallel. By being put into the release posture, the third locker 89 releases restriction of movement of the second edge guide 52.

### Operation of Second Embodiment

The operation of the present embodiment will be explained.

As shown in FIG. 18, the user mounts the medium placement device 16 on the recording device 11 by pushing the medium placement device 16 in the width direction X. The user takes out the medium placement device 16 from the recording device 11 by pulling out the medium placement device 16 in the direction opposite to the width direction X.

The first edge guide 51 and the second edge guide 52 move the medium 18 together with the medium placement device 16. That is, the first edge guide 51 and the second edge guide 52 restrict movement of the medium 18 in the width direction X or the direction opposite to the width direction X with respect to the medium placement device 16 when the medium placement device 16 is attached or detached. Therefore, the first edge guide 51 and the second edge guide 52 receive a force from the medium 18 in a direction in which the first edge guide 51 and the second edge guide 52 separate from each other. For example, when the user moves the medium placement device 16 with great force, the first edge guide 51 and the second edge guide 52 that receive force from the medium 18 may be inclined outward.

As shown in FIG. 8, since the first edge guide 51 is the same as that of the first embodiment, the first locker 69 is positioned outside and the second locker 70 is positioned inside. In other words, the first locker 69 is located at a position separated from the first contact section 55. The second locker 70 is located at a position close to the first contact section 55.

The medium 18 that collided with the first edge guide 51 pushes the first contact section 55 in a direction away from the second edge guide 52. The pushed first contact section 55 may be inclined outward. When the first contact section 55 is tilted and, for example, a wall on the back side of the first contact section 55 contacts the second locker 70, the second locker 70 is displaced from the tilted posture.

The first locker 69 restricts movement of the first edge guide 51 in the direction away from the second edge guide 52. The second locker 70 restricts movement of the first edge guide 51 in a direction approaching the second edge guide 52. Therefore, even when the first edge guide 51 receives a force in a direction away from the second edge guide 52 and the restriction of movement by the second locker 70 is relaxed, the first edge guide 51 is unlikely to move in a direction away from the second edge guide 52.

The second edge guide 52 in the first embodiment and the second embodiment have different configurations.

As shown in FIG. 15, in the second edge guide 52 in the first embodiment, the third locker 89 is positioned on the inner side, and the fourth locker 90 is positioned on the outer side. In other words, the third locker 89 is located at a position close to the second contact section 56. The fourth locker 90 is located at a position separated from the second contact section 56.

The medium 18 that collided with the second edge guide 52 pushes the second contact section 56 in a direction away from the first edge guide 51. The pushed second contact section 56 may incline outward. When the second contact section 56 is tilted and, for example, a wall on the back side of the second contact section 56 contacts the third locker 89, the third locker 89 is displaced from the tilted posture.

The third locker 89 restricts movement of the second edge guide 52 in a direction away from the first edge guide 51. The fourth locker 90 restricts movement of the second edge guide 52 in a direction approaching the first edge guide 51. Therefore, when the second edge guide 52 receives a force in a direction away from the first edge guide 51 and restriction of movement by the third locker 89 is relaxed, the second edge guide 52 may move in a direction away from the first edge guide 51.

The interlocking section 63 moves the second edge guide 52 in conjunction with the first edge guide 51 moving along the first guide shaft 59. When the second edge guide 52 is pushed by the medium 18 and moves, the interlocking section 63 also transmits the force to the first edge guide 51. In the first edge guide 51 that received the force in the direction away from the second edge guide 52, meshing between the first locker 69 and the first guide shaft 59 may become stronger. The meshing between the first locker 69 and the first guide shaft 59 gradually accumulates every time the medium placement device 16 is attached and detached. When meshing between the first locker 69 and the first guide shaft 59 becomes strong, the force required to operate the first operation section 68 becomes large.

Therefore, in the first embodiment, it is preferable that the second edge guide 52 is designed so that the wall on the back side of the second contact section 56 has sufficient space so as not to come into contact with the third locker 89.

As shown in FIG. 20, the second edge guide 52 in the second embodiment does not have the fourth locker 90. Therefore, the force of the second edge guide 52 that restricts movement in the direction approaching the first edge guide 51 is weak.

The third locker 89 in the tilted posture is displaced to the release posture so that the third arm section 96 approaches the second contact section 56. Therefore, even when the second contact section 56 is pushed by the medium 18 and falls outward, the third locker 89 easily maintains the tilted posture. Therefore, even when the second edge guide 52 receives a force in a direction away from the first edge guide 51, movement of the second edge guide 52 is restricted by the third locker 89.

### Effects of Second Embodiment

Effects of the present embodiment will be described.

(2-1) The first edge guide 51 and the second edge guide 52 may be hit by the medium 18 and receive an impact when, for example, the medium placement device 16 is attached or detached. The interlocking section 63 transmits the impact received by one edge guide to the other edge guide, and thus the meshing between the locker and the guide shaft may become tight. When movement of the first edge guide 51 and the second edge guide 52 is suppressed in both directions, the meshing force accumulates, and a large force may be required to operate the first operation section 68 or the second operation section 88. In this regard, the second edge guide 52 includes a third locker 89. That is, since the second edge guide 52 is configured to not include the fourth locker 90, it is possible to suppress accumulation of meshing force.

(2-2) In the third locker 89 in the tilted posture, plural sections of the edge of the third hole 97, which are located at different positions in the vertical direction Z, contact the second guide shaft 60. Therefore, even when the second edge guide 52 pushed by the medium 18 is tilted with respect to the vertical direction Z, it is possible to easily maintain the third locker 89 in the tilted posture.

### Modifications

The present embodiment can be implemented with the following modifications. The embodiments and the following modifications can be implemented in combination with each other as long as there is no technical contradiction.
At least one of the first guide shaft 59 to the third guide shaft 61 may be provided obliquely with respect to the width direction X and the feed direction D.
At least one of the first edge guide 51 to the third edge guide 53 may align the corners of the medium 18.
The medium placement device 16 may include two guide shafts for a single edge guide.

For example, the medium placement device 16 may include two first guide shafts 59 that guide movement of the first edge guide 51. The two first guide shafts 59 are provided in parallel. Different first guide shafts 59 may be inserted separately through the first locker 69 and the second locker 70.
In a case where the interlocking section 63 interlocks movement of the first edge guide 51 and the second edge guide 52, one of the first locker 69 and the second locker 70 may be provided in the first edge guide 51, and the other may be provided in the second edge guide 52.
In a case where the interlocking section 63 interlocks movement of the first edge guide 51 and the second edge guide 52, it may have a configuration in which the first edge guide 51 has the first locker 69 and the second locker 70, and the second edge guide 52 does not have the third locker 89 and the fourth locker 90.
In a case where the first edge guide 51 includes the first locker 69 and the second locker 70, the second edge guide 52 may include one of the third locker 89 and the fourth locker 90.
In a case where the interlocking section 63 interlocks movement of the first edge guide 51 and the second edge guide 52, it may be a configuration in which the first edge guide 51 does not include the first locker 69 and the second locker 70, and the second edge guide 52 includes the third locker 89 and the fourth locker 90.
In a case where the second edge guide 52 includes the third locker 89 and the fourth locker 90, the first edge guide 51 may include one of the first locker 69 and the second locker 70.
The first edge guide 51 and the second edge guide 52 may have the same configuration. The first edge guide 51 may include the third locker 89 and the fourth locker 90. The first edge guide 51 may include the second operation section 88. The first edge guide 51 may be capable of maintaining a state where movement restriction is released. The second edge guide 52 may include the first locker 69 and the second locker 70. The second edge guide 52 may include the first operation section 68. The movement restriction of the second edge guide 52 may be released only while the user is operating it.
The second edge guide 52 may be positioned between the first edge guide 51 and the front wall 45 in the width direction X. The distance from the pull section 46 to the first edge guide 51 may be longer than the distance from the pull section 46 to the second edge guide 52.
The third edge guide 53 may have the same configuration as the second edge guide 52. The third edge guide 53 may not have the same configuration as the first edge guide 51, and may not have the same configuration as the second edge guide 52.
The medium placement device 16 may include any one of the first edge guide 51 to the third edge guide 53. The medium placement device 16 may include any two of the first edge guide 51 to the third edge guide 53.
The first edge guide 51 may not include the first operation section 68. The user may directly change the postures of the first locker 69 and the second locker 70.
The first operation section 68 may change the posture of one of the first locker 69 and the second locker 70. The first edge guide 51 may include separately an operation section for changing the posture of the first locker 69 and an operation section for changing the posture of the second locker 70.
The medium placement device 16 may not include the interlocking section 63. The first edge guide 51 and the second edge guide 52 may be movable separately.
The first guide shaft 59 and the second guide shaft 60 may be integrally formed. The same guide shaft may be passed through the first locker 69 to the fourth locker 90.
The third guide shaft 61 may intersect at least one of the first guide shaft 59 and the second guide shaft 60. The third guide shaft 61 may intersect the first guide shaft 59 and the second guide shaft 60 that are integrally formed. The third guide shaft 61 may be formed integrally with at least one of the first guide shaft 59 and the second guide shaft 60.
The first edge guide 51 may not include at least one of the first stopper 84 and the second stopper 86. For example, the first locker 69 and the second locker 70 may be connected to each other on the side opposite to the first arm section 76 and the second arm section 79. By connecting the first locker 69 and the second locker 70, it is possible to reduce the possibility that the first locker 69 and the second locker 70 fall down when the first locker 69 and the second locker 70 are set to the release posture.
The first edge guide 51 may not include the first restriction section 82. The second edge guide 52 may not include the second restriction section 102.
The first edge guide 51 may not include the second biasing section 72. The first operation section 68 located at the lock position may contact the first arm section 76 and the second arm section 79.
The first biasing section 71 may be a sponge, rubber, or the like that is positioned between the first locker 69 and the second locker 70. The first biasing section 71 may be a tension spring provided outside the first locker 69 and the second locker 70.
The first edge guide 51 may separately include a first biasing section 71 that biases the first locker 69 and a first biasing section 71 that biases the second locker 70.
The apparatus to which the medium placement device 16 is mounted may be an apparatus for sending the medium 18 to the recording device 11, a scanner, a facsimile, a dry paper machine, or the like.
The recording device 11 may be a laser printer, a thermal printer, a dot impact printer, a digital printing machine, or the like.
The recording device 11 may be a liquid ejecting apparatus that performs recording by spraying or ejecting liquid other than ink. The state of liquid that is ejected from the liquid ejection device as minute-quantity liquid droplets includes granular shapes, tear shapes, and shapes with a thread-like tail. Here, the liquid may be any material that can be ejected from the liquid ejection device. For example, the liquid may be in any state where a substance is in the liquid phase, and includes a fluid body such as a liquid body having high or low viscosity, a sol, gel water, other inorganic solvents, an organic solvent, a solution, a liquid resin, a liquid metal, and a metal melt. The liquid includes not only a liquid as one state of a substance but also a liquid in which particles of a functional material made of a solid material such as a pigment or metal particles are dissolved, dispersed, or mixed in a solvent. Typical examples of liquid include ink as described in the above embodiment and liquid crystal. Here, the ink includes various liquid compositions such as general water-based ink, oil-based ink, gel ink, and hot-melt ink. As a specific example of the liquid ejection device, there is a device that ejects liquid containing materials such as electrode materials or color materials used for manufacturing liquid crystal displays, electroluminescence displays, surface-emitting displays, color filters, or the like, in a dispersed or dissolved form. The liquid ejection device may be a device that ejects a bioorganic substance used for manufacturing a biochip, a device that is used as a precision pipette and ejects liquid serving as a sample, a textile printing device, a micro dispenser, or the like. The liquid ejection device may be a device that ejects lubricating oil to precision machinery such as watches or cameras in a pinpoint manner, or a device that ejects a transparent resin liquid such as an ultraviolet curable resin onto a substrate in order to form micro hemispherical lenses, optical lenses, or the like used in optical communication elements or the like. The liquid ejection device may be a device for ejecting an etching liquid such as an acid or an alkali for etching a substrate or the like.

### Definitions

As used herein, the phrase “at least one” means “one or more” of the desired alternatives. As an example, the phrase “at least one” as used herein means “only one option” or “both of two options” if the number of options is two. As another example, as used herein, the phrase “at least one” means “only one option”, “a combination of two options”, or “a combination of three or more options” if the number of options is three or more.

### Supplementary Notes

Hereinafter, technical ideas grasped from the above-described embodiment and modifications, and operations and effects thereof will be described.

(A) A medium placement device includes a placement section configured to have a medium placed thereon; an edge guide configured to align an edge of the medium placed on the placement section; and a guide shaft configured to guide movement of the edge guide, wherein the edge guide includes a contact section configured to contact the edge of the medium, a first locker in which is formed a first hole through which the guide shaft passes, a second locker in which is formed a second hole through which the guide shaft passes, and a first biasing section configured to bias the first locker and the second locker and the first locker and the second locker are biased by the first biasing section to tilt in different directions from each other.

According to this configuration, the first locker and the second locker are tilted in opposite directions to each other in a state where the guide shaft is inserted. Therefore, the edge guide can be prevented from moving in both directions with respect to the guide shaft.

(B) The medium placement device according to (A) may be such that the first biasing section is a spring positioned between the first locker and the second locker.

According to this configuration, the first biasing section is positioned between the first locker and the second locker.

The first biasing section is a spring. The first biasing section can tilt the first locker and the second locker in different directions by pressing the first locker and the second locker away from each other.

(C) The medium placement device according to (A) or (B) may be such that the edge guide further includes an operation section configured to change posture of the first locker and of the second locker against biasing force of the first biasing section and the operation section is configured to change a tilted posture of the first locker in which an edge of the first hole contacts the guide shaft to a release posture in which the edge of the first hole is separated from the guide shaft and change a tilted posture of the second locker in which an edge of the second hole contacts the guide shaft to a release posture in which the edge of the second hole is separated from the guide shaft.

According to this configuration, the operation section can change the posture of the first locker and the second locker from the tilted posture to the release posture. By setting the first locker and the second locker to the release posture, the restriction of movement of the edge guide can be released.

(D) The medium placement device according to (C) may be such that the first locker includes a first base section in which the first hole is formed and a first arm section that forms an obtuse angle with respect to the first base section and that extends toward the second locker, the second locker includes a second base section in which the second hole is formed and a second arm section that forms an obtuse angle with respect to the second base section and that extends toward the first locker, and the operation section contacts the first arm section and the second arm section between the first base section and the second base section in an axial direction of the guide shaft.

According to this configuration, the operation section contacts the first arm section and the second arm section at a position between the first base section and the second base section. Therefore, the postures of the first locker and the second locker can be changed by one operation section.

(E) The medium placement device according to (D) may be such that the operation section changes the first locker and the second locker to the release posture by pushing the first arm section and the second arm section, which intersect each other, so as to approach the guide shaft.

According to this configuration, the operation section changes the first locker and the second locker to the release posture by pressing the first arm section and the second arm section, which intersect each other. Therefore, movement restriction of the edge guide can be released by a simple operation.

(F) The medium placement device according to (E) may be such that the edge guide further includes a second biasing section configured to bias the operation section and the second biasing section separates the operation section from the first locker and the second locker.

According to this configuration, the operation section is separated from the first locker and the second locker by being biased by the second biasing section. Therefore, the states of the first locker and the second locker can be easily determined from the position of the operation section.

(G) The medium placement device according to (D) to (F) may be such that the edge guide includes a restriction section provided between the first locker and the second locker and the restriction section restricts the first base section from approaching the second base section and restricts the second base section from approaching the first base section.

According to this configuration, the restriction section restricts the first base section and the second base section from approaching each other. Therefore, even when a force is applied to the first arm section and the second arm section and the postures of the first locker and the second locker are changed, it is possible to suppress deformation of the first base section and the second base section.

(H) The medium placement device according to (G) may be such that the edge guide includes a first support section and a second support section, the first locker is configured to change its posture by rotating about the first support section as a fulcrum, the second locker is configured to change its posture by rotating about the second support section as a fulcrum, and the restriction section is located at a position that is between the first support section and the guide shaft and that is between the second support section and the guide shaft.

According to this configuration, the restriction section is positioned between the first support section and the guide shaft. The restriction section is positioned between the second support section and the guide shaft. Therefore, the first restriction section can efficiently suppress deformation of the first locker and the second locker.

(I) The medium placement device according to (H) may be such that a distance between the first support section and the restriction section is larger than a thickness of the first locker and a distance between the second support section and the restriction section is larger than a thickness of the second locker.

According to this configuration, the distance between the first support section and the restriction section is larger than the thickness of the first locker. Therefore, rotation of the first locker about the first support section as a fulcrum can occur between the first support section and the restriction section. The distance between the second support section and the restriction section is larger than the thickness of the second locker. Therefore, rotation of the second locker about the second support section as a fulcrum can occur between the second support section and the restriction section.

(J) The medium placement device according to (C) may be such that the operation section is configured to maintain the first locker and the second locker in the release posture.

According to this configuration, the operation section maintains the posture of the first locker and the second locker in the release posture. Therefore, the edge guide can be maintained in a state where restriction of movement is released.

(K) The medium placement device according to (C) to (J) may be such that the edge guide includes a first stopper and a second stopper, the first stopper contacts the first locker that changed from the tilted posture to the release posture, and the second stopper contacts the second locker that changed from the tilted posture to the release posture.

According to this configuration, the first stopper contacts the first locker in the release posture. The second stopper contacts the second locker in the release posture. Therefore, the postures of the first locker and the second locker can be easily determined.

(L) The medium placement device according to (A) to (K) may be such that the edge guide aligns an upstream edge of the medium in a feed direction.

According to this configuration, the edge guide aligns the upstream edge of the medium in the feed direction. Therefore, it is possible to easily and accurately feed the medium from the medium placement device.

(M) The medium placement device according to (A) to (L), assuming that the edge guide is a first edge guide, the contact section is a first contact section, and an edge of the medium that the first contact section is configured to contact is a first edge, may further include a second edge guide having a second contact section and an interlocking section, wherein the second contact section is configured to contact a third edge, which is opposite from the first edge in the width direction and the interlocking section moves the second edge guide in conjunction with the first edge guide moving along the guide shaft.

According to this configuration, the interlocking section moves the second edge guide in conjunction with movement of the first edge guide. Therefore, by restricting movement of the first edge guide, movement of the second edge guide can be restricted. Therefore, both edges of the medium in the width direction can be aligned with a simple configuration.

(N) The medium placement device according to (M) may further include a front wall provided with a pull section, wherein a distance from the pull section to the first edge guide is shorter than a distance from the pull section to the second edge guide.

According to this configuration, the medium placement device is provided with the pull section. For example, when the medium placement device is attached to or detached from another device, the user can easily perform the operation by hooking his/her hand on the pull section. The first edge guide is provided at a position close to the pull section. Therefore, movement restriction of the first edge guide can be easily released.

(O) The medium placement device according to (C), assuming that the edge guide is a first edge guide, the contact section is a first contact section, an edge of the medium that the first contact section is configured to contact is a first edge, and the operation section is a first operation section, may further include a second edge guide and an interlocking section, wherein the second edge guide includes a second contact section configured to contact a third edge, which is opposite from the first edge in the width direction, a third locker in which is formed a third hole through which the guide shaft passes, a third biasing section configured to bias the third locker, and a second operation section configured to change posture of the third locker against biasing force of the third biasing section, the interlocking section moves the second edge guide in conjunction with the first edge guide moving along the guide shaft, and the third locker restricts displacement of the second edge guide in a direction separating from the first edge guide.

The first edge guide and the second edge guide may receive an impact when the medium hits the edge guides, for example, when the medium placement device is attached or detached. Because the interlocking section transmits the impact received by one edge guide to the other edge guide, the meshing between the locker and the guide shaft may become tight. When movement of the first edge guide and the second edge guide in both directions is suppressed, the meshing force accumulates, and a large force may be required for operating the first operation section or the second operation section. In this regard, according to this configuration, the second edge guide includes the third locker. That is, since the second edge guide is configured not to include the fourth locker, accumulation of the meshing force can be suppressed.

(P) The medium placement device according to (O) may be such that the second operation section is configured to change the third locker from a tilted posture in which an edge of the third hole contacts the guide shaft to a release posture in which the edge of the third hole is separated from the guide shaft and in the tilted posture, a plurality of sections along the vertical direction of an edge of the third hole contact the guide shaft.

According to this configuration, when the third locker is in the tilted posture, plural sections of the edge of the third hole, which are located at different positions in the vertical direction, contact the guide shaft. Therefore, even when the second edge guide pushed by the medium is tilted with respect to the vertical direction, it is possible to easily maintain the third locker in the tilted posture.

(Q) The medium placement device according to (A) to (N) may be such that a plurality of the edge guides are provided and the plurality of edge guides include an edge guide that aligns a first edge of the medium and an edge guide that aligns a third edge of the medium, which is opposite from the first edge in the width direction.

According to this configuration, the plurality of edge guides align the first edge and the third edge of the medium.

Both edges of the medium in the width direction can be aligned by the plurality of edge guides of which movement is suppressed by the first locker and the second locker.

(R) The medium placement device according to (D) to (N) and (Q), assuming that the edge guide is a first edge guide, the contact section is a first contact section, an edge of the medium that the first contact section is configured to contact is a first edge, and the operation section is a first operation section, may further include a second edge guide, wherein the second edge guide includes a second contact section configured to contact a third edge, which is opposite from the first edge in the width direction, a third locker in which is formed a third hole through which the guide shaft passes, a fourth locker in which is formed a fourth hole through which the guide shaft passes, a third biasing section configured to bias the third locker and the fourth locker, and a second operation section configured to change posture of the third locker and posture of the fourth locker against biasing force of the third biasing section, the third locker and the fourth locker are biased by the third biasing section to tilt in different directions, the second operation section is configured to change the third locker from a tilted posture in which an edge of the third hole contacts the guide shaft to a release posture in which the edge of the third hole is separated from the guide shaft, the second operation section is configured to change the fourth locker from a tilted posture in which an edge of the fourth hole contacts the guide shaft to a release posture in which the edge of the fourth hole is separated from the guide shaft, and the second operation section is configured to maintain the third locker and the fourth locker in the release posture.

According to this configuration, the restriction on movement of the first edge guide is released by the operation of the first operation section. The restriction on movement of the second edge guide is released by the operation of the second operation section. Therefore, both edges of the medium in the width direction can be aligned.

(S) The medium placement device according to (R) may further include an interlocking section and a front wall provided with a pull section, wherein the interlocking section moves the second edge guide in conjunction with the first edge guide moving along the guide shaft, and a distance from the pull section to the first edge guide is shorter than a distance from the pull section to the second edge guide.

According to this configuration, the second operation section can maintain the second edge guide in a movable state.

When the first edge guide is moved with the second edge guide in the movable state, the interlocking section causes the second edge guide to move. Therefore, the second edge guide can be easily moved by moving the first edge guide close to the pull section.

(T) The medium placement device according to (A) to (N) and (Q) to(S) may be such that plural sets of edge guides and guide shafts are provided, and the plurality of edge guides include an edge guide that aligns a first edge of a medium and an edge guide that aligns a second edge of the medium intersecting the first edge.

According to this configuration, the plurality of edge guides align the first edge and the second edge of the medium.

The medium can be aligned in a plurality of directions by the plurality of edge guides whose movement is suppressed by the first locker and the second locker.

(U) The feed device may include a pickup roller that feeds the medium out from a medium placement device according to (A) to (T), and a load adjustment section that adjusts a load on the medium, and the load adjustment section may include a spring member that biases the pickup roller toward the medium, and a plurality of engagement sections with which the spring member engages.

According to this configuration, the load adjustment section includes the plurality of engagement sections with which the spring member engages. Therefore, the load can be easily adjusted by selecting a section to be engaged with the spring member from the plurality of engagement sections.

(V) The feed device according to (U) further includes a separation roller and a retard roller that separate the medium fed by the pickup roller, a retard shaft that supports the retard roller via a torque limiter, a driven gear provided on the retard shaft, a drive gear that transmits a drive force to the driven gear, a drive shaft on which the drive gear is provided, and a one-way clutch provided on the drive shaft. The force that the driven gear receives from the drive gear includes force in the direction in which the retard roller approaches the separation roller.

According to this configuration, the drive shaft is provided with the one-way clutch. The one-way clutch can suppress the reverse rotation of the drive shaft. Therefore, even when the drive force is not applied, the force with which the medium is sandwiched between the separation roller and the retard roller can be maintained by the force received by the driven gear from the drive gear.

(W) In the feed device according to (V), the positions of the driven gear and the drive gear in the axial direction of the retard shaft are adjustable.

According to this configuration, the positions of the drive gear and the driven gear can be adjusted. The load applied to the medium by the retard roller can be adjusted by changing the lever ratio by moving the drive gear and the driven gear.

(X) The feed device according to (V) or (W) may further include a cover section that covers the driven gear and the drive gear.

For example, when foreign matter such as paper dust or dirt adheres to the driven gear and the drive gear, the meshing ratio between the driven gear and the drive gear may change. In this regard, according to this configuration, the cover section covers the driven gear and the drive gear, and thus it is possible to reduce foreign matter adhering to the driven gear and the drive gear.

(Y) The feed device according to (V) to (X) may further include a first bearing and a second bearing that rotatably support the retard shaft, and a third bearing and a fourth bearing that rotatably support the drive shaft, the first bearing may be positioned in a first direction from the driven gear, the second bearing may be positioned in a second direction, which is opposite from the first direction, from the driven gear, the third bearing may be positioned in the first direction from the drive gear, and the fourth bearing may be positioned in the second direction from the drive gear. An outer diameter of the first bearing may be larger than an outer diameter of the second bearing, and an outer diameter of the fourth bearing may be larger than an outer diameter of the third bearing.

According to this configuration, the first bearing has a larger outer diameter than the second bearing. The third bearing has a smaller outer diameter than the fourth bearing. The first bearing and the third bearing are positioned in the first direction from the driven gear and the drive gear. That is, the first bearing, which is larger, and the third bearing, which is smaller, are positioned in the first direction from the driven gear and the drive gear. Similarly, the second bearing, which is smaller, and the fourth bearing, which is larger, are positioned on the opposite side of the first bearing and the third bearing. Therefore, the drive shaft and the retard shaft can be disposed closer to each other compared to a case where the first bearing, the second bearing, the third bearing, and the fourth bearing are equal in size.

What is claimed is:

1. A medium placement device comprising:
a placement section configured to have a medium placed thereon;
an edge guide configured to align an edge of the medium placed on the placement section; and
a guide shaft configured to guide movement of the edge guide, wherein
the edge guide includes
a contact section configured to contact the edge of the medium,
a first locker in which is formed a first hole through which the guide shaft passes,
a second locker in which is formed a second hole through which the guide shaft passes, and
a first biasing section configured to bias the first locker and the second locker and
the first locker and the second locker are biased by the first biasing section to tilt in different directions from each other.

2. The medium placement device according to claim 1, wherein
the first biasing section is a spring positioned between the first locker and the second locker.

3. The medium placement device according to claim 1, wherein
the edge guide further includes an operation section configured to change posture of the first locker and of the second locker against biasing force of the first biasing section and
the operation section is configured to
change a tilted posture of the first locker in which an edge of the first hole contacts the guide shaft to a release posture in which the edge of the first hole is separated from the guide shaft and
change a tilted posture of the second locker in which an edge of the second hole contacts the guide shaft to a release posture in which the edge of the second hole is separated from the guide shaft.

4. The medium placement device according to claim 3, wherein
the first locker includes
a first base section in which the first hole is formed and
a first arm section that forms an obtuse angle with respect to the first base section and that extends toward the second locker,
the second locker includes
a second base section in which the second hole is formed and
a second arm section that forms an obtuse angle with respect to the second base section and that extends toward the first locker, and
the operation section contacts the first arm section and the second arm section between the first base section and the second base section in an axial direction of the guide shaft.

5. The medium placement device according to claim 4, wherein
the operation section changes the first locker and the second locker to the release posture by pushing the first arm section and the second arm section, which intersect each other, so as to approach the guide shaft.

6. The medium placement device according to claim 5, wherein
the edge guide further includes a second biasing section configured to bias the operation section and
the second biasing section separates the operation section from the first locker and the second locker.

7. The medium placement device according to claim 4, wherein
the edge guide includes a restriction section provided between the first locker and the second locker and
the restriction section restricts the first base section from approaching the second base section and restricts the second base section from approaching the first base section.

8. The medium placement device according to claim 7, wherein
the edge guide includes a first support section and a second support section,
the first locker is configured to change its posture by rotating about the first support section as a fulcrum,
the second locker is configured to change its posture by rotating about the second support section as a fulcrum, and
the restriction section is located at a position that is between the first support section and the guide shaft and that is between the second support section and the guide shaft.

9. The medium placement device according to claim 8, wherein
a distance between the first support section and the restriction section is larger than a thickness of the first locker and
a distance between the second support section and the restriction section is larger than a thickness of the second locker.

10. The medium placement device according to claim 3, wherein
the operation section is configured to maintain the first locker and the second locker in the release posture.

11. The medium placement device according to claim 3, wherein
the edge guide includes a first stopper and a second stopper,
the first stopper contacts the first locker that changed from the tilted posture to the release posture, and
the second stopper contacts the second locker that changed from the tilted posture to the release posture.

12. The medium placement device according to claim 1, wherein
the edge guide aligns an upstream edge of the medium in a feed direction.

13. The medium placement device according to claim 1, assuming that the edge guide is a first edge guide,
the contact section is a first contact section, and
an edge of the medium that the first contact section is configured to contact is a first edge,
the medium placement device further comprising:
a second edge guide having a second contact section and
an interlocking section, wherein
the second contact section is configured to contact a third edge, which is opposite from the first edge in the width direction and
the interlocking section moves the second edge guide in conjunction with the first edge guide moving along the guide shaft.

14. The medium placement device according to claim 13, further comprising:
a front wall provided with a pull section, wherein
a distance from the pull section to the first edge guide is shorter than a distance from the pull section to the second edge guide.

15. The medium placement device according to claim 3, assuming that
the edge guide is a first edge guide,
the contact section is a first contact section,
an edge of the medium that the first contact section is configured to contact is a first edge, and
the operation section is a first operation section,
the medium placement device further comprising:
a second edge guide and
an interlocking section, wherein
the second edge guide includes
a second contact section configured to contact a third edge, which is opposite from the first edge in the width direction,
a third locker in which is formed a third hole through which the guide shaft passes,
a third biasing section configured to bias the third locker, and
a second operation section configured to change posture of the third locker against biasing force of the third biasing section,
the interlocking section moves the second edge guide in conjunction with the first edge guide moving along the guide shaft, and
the third locker restricts displacement of the second edge guide in a direction separating from the first edge guide.

16. The medium placement device according to claim 15, wherein
the second operation section is configured to change the third locker from a tilted posture in which an edge of the third hole contacts the guide shaft to a release posture in which the edge of the third hole is separated from the guide shaft and
in the tilted posture, a plurality of sections along the vertical direction of an edge of the third hole contact the guide shaft.

17. The medium placement device according to claim 1, wherein
a plurality of the edge guides are provided and
the plurality of edge guides include an edge guide that aligns a first edge of the medium and an edge guide that aligns a third edge of the medium, which is opposite from the first edge in the width direction.

18. The medium placement device according to claim 4, assuming that
the edge guide is a first edge guide,
the contact section is a first contact section,
an edge of the medium that the first contact section is configured to contact is a first edge, and
the operation section is a first operation section,
the medium placement device further comprising:
a second edge guide, wherein
the second edge guide includes
a second contact section configured to contact a third edge, which is opposite from the first edge in the width direction,
a third locker in which is formed a third hole through which the guide shaft passes,
a fourth locker in which is formed a fourth hole through which the guide shaft passes,
a third biasing section configured to bias the third locker and the fourth locker, and
a second operation section configured to change posture of the third locker and posture of the fourth locker against biasing force of the third biasing section,
the third locker and the fourth locker are biased by the third biasing section to tilt in different directions,
the second operation section is configured to change the third locker from a tilted posture in which an edge of the third hole contacts the guide shaft to a release posture in which the edge of the third hole is separated from the guide shaft,
the second operation section is configured to change the fourth locker from a tilted posture in which an edge of the fourth hole contacts the guide shaft to a release posture in which the edge of the fourth hole is separated from the guide shaft, and
the second operation section is configured to maintain the third locker and the fourth locker in the release posture.

19. The medium placement device according to claim 18, further comprising:
an interlocking section and
a front wall provided with a pull section, wherein
the interlocking section moves the second edge guide in conjunction with the first edge guide moving along the guide shaft and
a distance from the pull section to the first edge guide is shorter than a distance from the pull section to the second edge guide.
